(19) United States
(12) Patent Application Publication
(10) Pub. No.: US 2024/0404743 A1
(43) Pub. Date: Dec. 5, 2024

(54) MAGNETIC CORE AND MAGNETIC COMPONENT

(71) Applicant: TDK CORPORATION, Tokyo (JP)

(72) Inventors: Masahito KOEDA, Tokyo (JP); Kensuke ARA, Tokyo (JP); Satoko MORI, Tokyo (JP)

(73) Assignee: TDK CORPORATION, Tokyo (JP)

(21) Appl. No.: 18/677,053

(22) Filed: May 29, 2024

(30) Foreign Application Priority Data
May 31, 2023 (JP) 2023-090240

(51) Int. Cl. H01F 27/255; H01F 27/28

(52) U.S. Cl. CPC H01F 27/255; H01F 27/28

(57) ABSTRACT

A magnetic core includes a soft magnetic powder. The soft magnetic powder accounts for an area ratio of 75% or more and 90% or less of a section of the magnetic core on average. The area ratio of the soft magnetic powder has a distribution with a skewness of 0.01 or more in absolute value. The distribution of the area ratio of the soft magnetic powder is identified by calculating area ratios of the soft magnetic powder in respective square regions defined by dividing the section of the magnetic core using a regular-interval grid.

### TECHNICAL FIELD

The present disclosure relates to a magnetic core including a soft magnetic powder and a magnetic component including the magnetic core.

### BACKGROUND

Magnetic components, such as inductors, transformers, and choke coils, are included a lot in, for example, power supply circuits of various electronic devices. For improvement of magnetic properties, attempts have been made to increase the packing density of a soft magnetic powder included in magnetic cores of the magnetic components. For example, Patent Document 1 discloses that using two types of metal magnetic powders with different particle sizes as soft magnetic powders can increase the packing densities of the soft magnetic powders of the magnetic cores to improve magnetic properties, such as permeability.

However, the increase in the packing densities of the soft magnetic powders of the magnetic cores increases contact points between magnetic particles to cause local magnetic saturation, which may reduce DC superimposition characteristics.
Patent Document 1: JP Patent Application Laid Open No. 2011-192729

### SUMMARY

It is an object of an exemplary embodiment of the present disclosure to provide a magnetic core and a magnetic component having excellent DC superimposition characteristics.

To achieve the above object, a magnetic core according to the present disclosure includes a soft magnetic powder, wherein the soft magnetic powder accounts for an area ratio of 75% or more and 90% or less of a section of the magnetic core on average; and the area ratio has a distribution with a skewness of 0.01 or more in absolute value, the skewness being identified by calculating area ratios of the soft magnetic powder in respective square regions, the square regions being defined by dividing the section using a regular-interval grid and having an area of (2D_{MAX})² each, where D_{MAX} denotes a maximum particle size of the soft magnetic powder in the section.

Having the above characteristics, the magnetic core can have high permeability and excellent DC superimposition characteristics at the same time.

Preferably, the skewness of the distribution of the area ratio is 0.05 or more in absolute value.

A magnetic component according to the present disclosure includes the magnetic core and a coil.

### BRIEF DESCRIPTION OF THE DRAWING(S)

FIG. 1 is a sectional schematic view of a magnetic core according to an embodiment of the present disclosure.

FIG. 2 is an example graph of a particle size distribution of a soft magnetic powder.

FIG. 3A is a schematic view of a method of measuring an area ratio of the soft magnetic powder.

FIG. 3B is a schematic view of the method of measuring the area ratio of the soft magnetic powder.

FIG. 4 is a graph of an example area ratio distribution of the soft magnetic powder.

FIG. 5 is a sectional schematic view of an example magnetic component including the magnetic core illustrated in FIG. 1.

FIG. 6A is a graph of a relationship between an average area ratio (packing density) and a DC superimposition rated current (Isat) of soft magnetic powders.

FIG. 6B is a graph of a relationship between the average area ratio (packing density) and initial permeability (i) of the soft magnetic powders.

FIG. 6C is a graph of a relationship between initial permeability and a DC superimposition rated current.

FIG. 7 is a graph of a relationship between initial permeability and a DC superimposition rated current.

FIG. 8 is a graph of a relationship between initial permeability and a DC superimposition rated current.

FIG. 9 is a graph of a relationship between an absolute value of skewness and a DC superimposition rated current.

### DETAILED DESCRIPTION

An embodiment of the present disclosure is described below with reference to the drawings. The embodiment of the present disclosure described below is an exemplification illustrative of the present disclosure; and elements, such as numerical values, shapes, materials, and manufacturing steps, according to the embodiment may be modified or changed to the extent that technical problems do not arise.

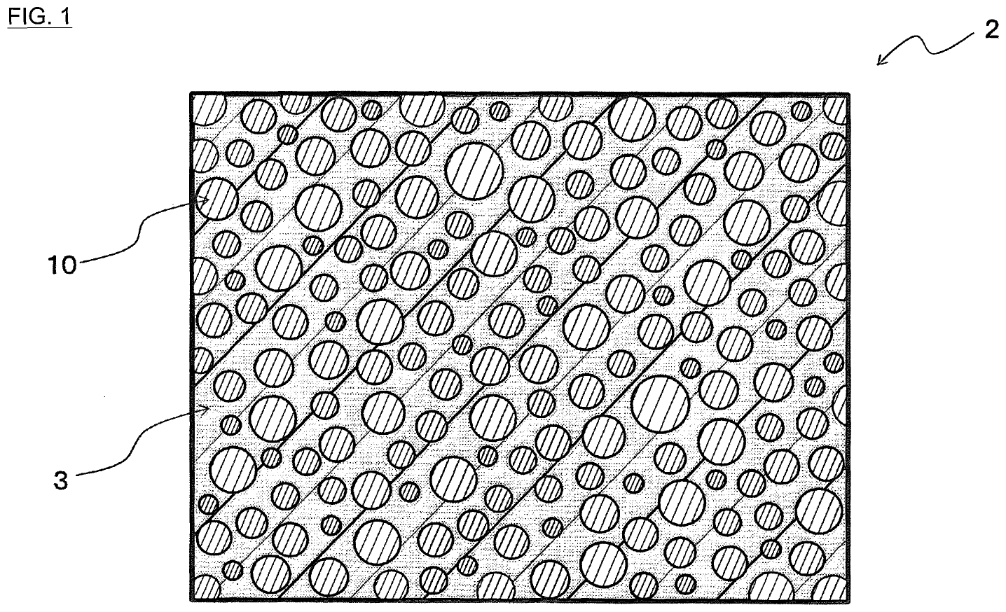

A magnetic core 2 according to the present embodiment is a composite magnetic body including a soft magnetic powder 1 and a resin 3. The soft magnetic powder 1 includes metal particles 10 made from soft magnetic metal. As illustrated in FIG. 1, the metal particles 10 of the soft magnetic powder 1 are dispersed in the resin 3 and are bonded by the resin 3 to form a predetermined shape of the magnetic core 2. The magnetic core 2 may have any external dimensions and any shape. The magnetic core 2 may have pores or include modifiers or the like in addition to the soft magnetic powder 1 and the resin 3.

The metal particles 10 may have any composition and any structure. The metal particles 10 may have, for example, a crystalline structure, a nanocrystalline structure, or an amorphous structure. Examples of soft magnetic metal having a crystalline structure include pure iron, pure cobalt, Fe—Ni alloys, Fe—Si alloys, Fe—Si—Cr alloys, Fe—Si—Al alloys, Fe—Si—Al—Ni alloys, Fe—Ni—Si—Co alloys, Fe—Co alloys, Fe—Co—V alloys, Fe—Co—Si alloys, and Fe—Co—Si—Al alloys. Examples of soft magnetic metal having a nanocrystalline structure or an amorphous structure include Fe—Si—B alloys, Fe—Si—B—C alloys, Fe—Si—B—C—Cr alloys, Fe—Nb—B alloys, Fe—Nb—B—P alloys, Fe—Nb—B—Si alloys, Fe—Co—P—C alloys, Fe—Co—B alloys, Fe—Co—B—Si alloys, Fe—Si—B—Nb—Cu alloys, Fe—Si—B—Nb—P alloys, Fe—Co—B—P—Si alloys, and Fe—Co—B—P—Si—Cr alloys.

The composition of the metal particles 10 can be analyzed using, for example, an energy dispersive X-ray spectroscopy apparatus (EDX apparatus) or an electron probe micro-analyzer (EPMA). Alternatively, the composition of the metal particles 10 may be analyzed using a three-dimensional atom probe (3DAP). When 3DAP is used, small regions (e.g., regions with a size of Φ 20 nm×100 nm) can be determined inside the metal particles 10 subject to measurement to measure their average composition, and the composition of the particles themselves can be identified without being affected by, for example, a resin component included in the magnetic core 2 or oxidation of particle surfaces.

The structure of the metal particles 10 can be analyzed using, for example, X-ray diffraction (XRD) or electron diffraction. An “amorphous structure” in the present embodiment refers to a structure having an amorphous ratio of 85% or more or a structure having no spot attributed to crystals detected by electron diffraction. Amorphous structures include an approximately amorphous structure or a hetero-amorphous structure. In the hetero-amorphous structure, crystals in an amorphous solid have an average size (average crystal grain size) of preferably 0.1 nm or more and 10 nm or less. A “nanocrystalline structure” in the present embodiment refers to a structure having an amorphous ratio of less than 85% and an average crystal grain size of 100 nm or less (preferably 3 nm to 50 nm). A “crystalline structure” in the present embodiment refers to a structure having an amorphous ratio of less than 85% and an average crystal grain size of above 100 nm.

When the structure of the metal particles 10 is analyzed using XRD, the amorphous ratio can be represented by a ratio of amorphous scattering integrated intensity to the sum of crystal scattering integrated intensity and amorphous scattering integrated intensity. Alternatively, an electron microscope may be used to identify amorphous portions and crystalline portions of the inside of the metal particles 10, and the amorphous ratio may be found using the proportion of the area of the amorphous portions in the metal particles 10.

The metal particles 10 may have any particle sizes and may have an average particle size of, for example, 1 μm or more and 100 μm or less. The particle sizes of the metal particles 10 can be measured using an image analysis of a section of the magnetic core 2. The “particle sizes” in the present embodiment refer to equivalent circle diameters of the metal particles 10 observed in the section of the magnetic core 2. The equivalent circle diameter of each metal particle 10 is represented by (4α/π)^{1/2}, where α denotes the area of the metal particle 10 in the section of the magnetic core 2. A particle size distribution of the soft magnetic powder 1 is identified by preferably measuring the equivalent circle diameters of at least one hundred metal particles 10 in the section of the magnetic core 2. The average particle size of the metal particles 10 is identified by calculating an arithmetic mean of the measured equivalent circle diameters.

The metal particles 10 may have any shapes and have an average circularity of preferably 0.80 or more, or more preferably 0.90 or more. The circularity of each metal particle 10 is represented by 2(πα)^{1/2}/L, where α denotes the area of the metal particle 10 in the section of the magnetic core 2 and L denotes the perimeter of the metal particle 10. The average circularity is calculated by preferably measuring the circularities of at least one hundred metal particles 10.

The soft magnetic powder 1 preferably includes insulation films covering respective particle surfaces. The insulation films may be provided for the respective metal particles 10 constituting the soft magnetic powder 1; or the soft magnetic powder 1 may include the metal particles 10 with the insulation films and the metal particles 10 without the insulation films. The insulation films may be made from any material. The insulation films can be, for example, films (oxidized films) from oxidation of the particle surfaces or films containing BN, SiO₂, MgO, Al₂O₃, phosphate, silicate, borosilicate, bismuthate, or an inorganic material (e.g., various glass). The insulation films preferably include films of oxide glass.

Examples of oxide glass include silicate (SiO₂) based glass, phosphate (P₂O₅) based glass, bismuthate (Bi₂O₃) based glass, and borosilicate (B₂O₃—SiO₂) based glass. More specifically, examples of silicate based glass include SiO₂ (Si—O based glass), soda-lime glass (Si—Na—Ca—O based glass), Si—Ba—Mn—O based glass, and Si—Mn—Ca—Na—O based glass. Examples of phosphate based glass include P₂O₅ (P—O based glass), P—Zn—Al—O based glass, and P—Zn—Al—R—O based glass (“R” includes at least one element selected from alkali metals). Examples of bismuthate based glass include Bi—Zn—B—Si—O based glass and Bi—Zn—B—Si—Al—O based glass. Examples of borosilicate based glass include Ba—Zn—B—Si—Al—O based glass.

The insulation films may have a multilayer structure with two or more types of layers. The insulation films have an average thickness of preferably 1 nm or more and 100 nm or less or more preferably 5 nm or more and 50 nm or less.

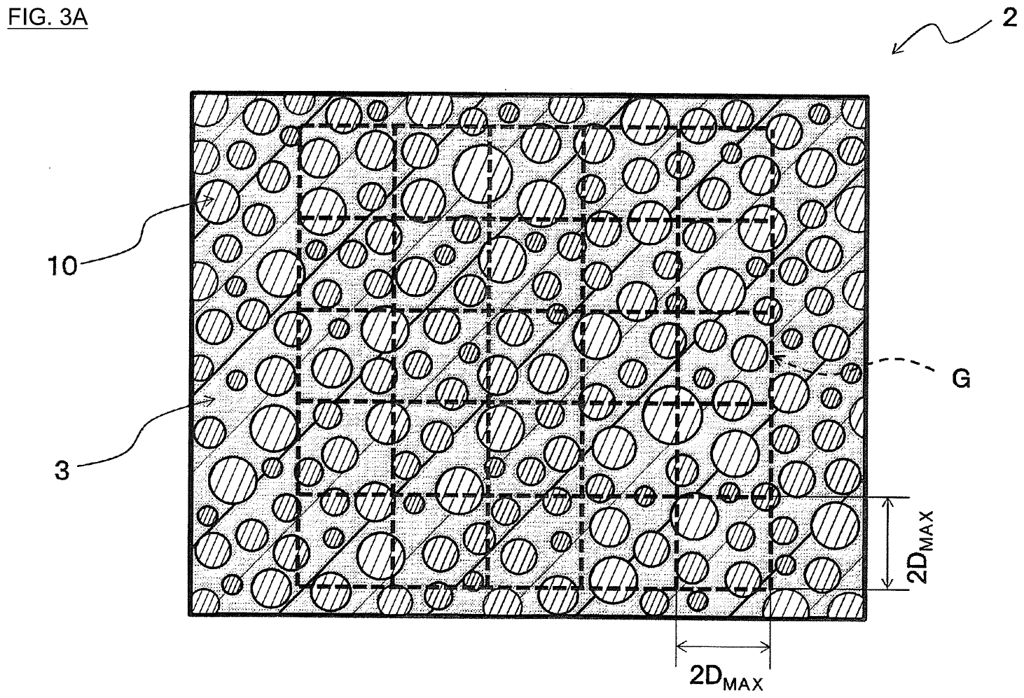

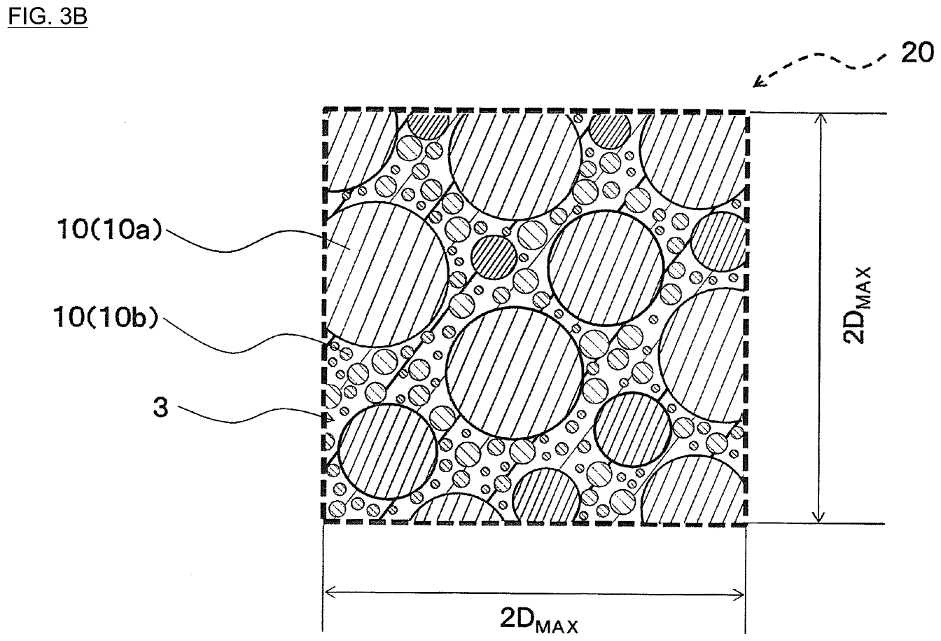

The soft magnetic powder 1 may be made up of one type of powder but preferably includes two or more types of particle groups with different particle compositions and/or different particle sizes. For example, as illustrated in FIG. 3B, the soft magnetic powder 1 preferably includes, as the metal particles 10, large particles 10a and small particles 10b having smaller particle sizes than the large particles 10a.

When the soft magnetic powder 1 includes the large particles 10a and the small particles 10b, the large particles 10a have an average particle size of preferably 5 μm or more and 40 μm or less or more preferably 10 μm or more and 35 μm or less. By contrast, the small particles 10b have an average particle size of preferably 2 μm or less or more preferably 0.2 μm or more and less than 2 μm. The large particles 10a may have a crystalline structure, a nanocrystalline structure, or an amorphous structure; and in terms of reducing coercivity, the large particles 10a preferably have a nanocrystalline structure or an amorphous structure. By contrast, the small particles 10b are preferably made from soft magnetic metal having a crystalline structure with a high saturation magnetic flux density, such as pure iron, pure cobalt, Fe—Ni alloys, Fe—Si alloys, or Fe—Co alloys.

The percentages of the large particles 10a and the small particles 10b included in the magnetic core 2 are not limited. For example, the ratio of the total area of the large particles 10a to the total area of the metal particles 10 in a section of the magnetic core 2 is preferably 50% or more and 90% or less, or more preferably 60% or more and 80% or less. The ratio of the total area of the small particles 10b to the total area of the metal particles 10 is preferably 5% or more and 50% or less, or more preferably 5% or more and 30% or less.

The soft magnetic powder 1 may include, as the metal particles 10, medium particles 10c together with the large particles 10a and the small particles 10b. The medium particles 10c may have any average particle size. The average particle size is preferably, for example, 3 μm or more and 5 μm or less. The medium particles 10c may have a crystalline structure, a nanocrystalline structure, or an amorphous structure; and in terms of reducing coercivity, the medium particles 10c preferably have a nanocrystalline structure or an amorphous structure. The percentage of the medium particles 10c is not limited. For example, the ratio of the total area of the medium particles 10c to the total area of the metal particles 10 is preferably 5% or more and 30% or less.

When the soft magnetic powder 1 includes two or more types of particle groups as described above, the soft magnetic powder 1 may include a particle group that does not have insulation films; however, all of the large particles 10a, the medium particles 10c, and the small particles 10b preferably have the insulation films. In this case, the particle groups may have the insulation films of the same material or may have the insulation films of different materials. Each particle group may have any average circularity; however, the large particles 10a, the medium particles 10c, and the small particles 10b each preferably have an average circularity of 0.80 or more.

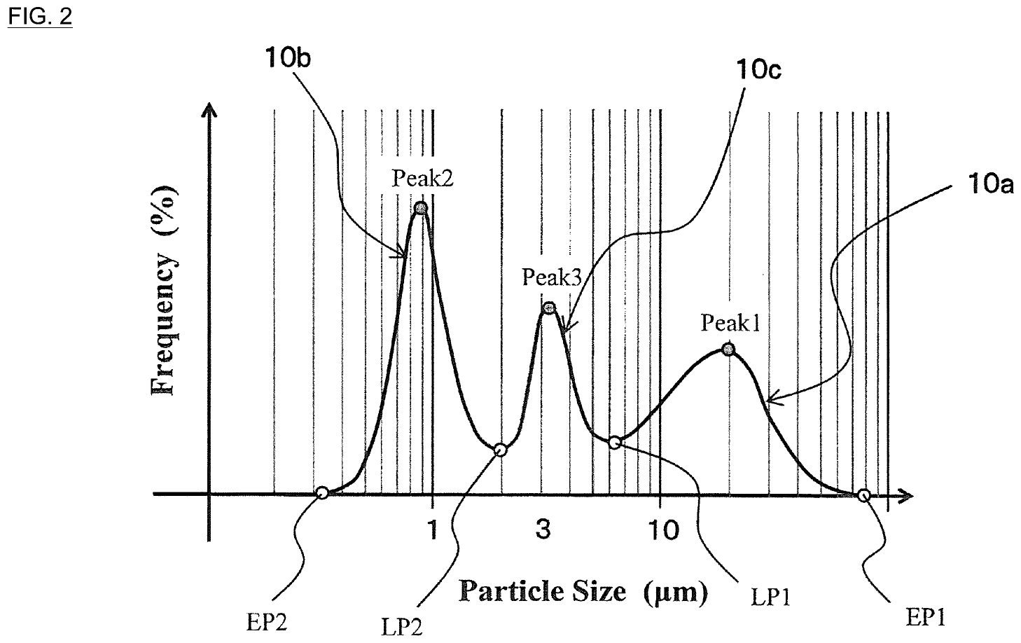

The large particles 10a, the medium particles 10c, and the small particles 10b can be distinguished by classifying the metal particles 10 included in a section of the magnetic core 2 based on their compositions using a surface analysis with an EDX apparatus or an EPMA. Alternatively, the large particles 10a, the medium particles 10c, and the small particles 10b may be distinguished based on the particle size distribution of the soft magnetic powder 1. For example, FIG. 2 illustrates an example particle size distribution of the soft magnetic powder 1. When the particle size distribution illustrated in FIG. 2 is identified, the large particles 10a, the medium particles 10c, and the small particles 10b may be identified as follows. A particle group under Peak 1 furthest on the large size side (a particle group ranging from LP1 to EP1) may be identified as the large particles 10a. A particle group under Peak 2 furthest on the small size side (a particle group ranging from EP2 to LP2) may be identified as the small particles 10b. A particle group under Peak 3 between Peaks 1 and 2 (a particle group ranging from LP2 to LP1) may be identified as the medium particles 10c.

The resin 3 is an insulating binding material with which the soft magnetic powder 1 is fixed in a predetermined dispersion state. Materials of the resin 3 are not limited. For example, the resin 3 may include a thermoplastic resin; however, the resin 3 preferably includes a thermosetting resin (e.g., epoxy resin, phenol resin, or silicone resin) or more preferably includes epoxy resin.

The packing density of the soft magnetic powder 1 of the magnetic core 2 is represented by an area ratio of the soft magnetic powder 1 in a section of the magnetic core 2. The “area ratio of the soft magnetic powder 1” refers to the ratio of the total area of the metal particles 10 included in the section of the magnetic core 2 to the area of the section. In the present embodiment, an area ratio distribution of the soft magnetic powder 1 of the magnetic core 2 is identified by dividing a section of the magnetic core 2 into analysis regions and measuring the area ratios of the soft magnetic powder 1 in the respective analysis regions. A method of identifying the area ratio distribution is described below in detail with reference to FIGS. 3A and 3B.

First, a section of the magnetic core 2 is observed using a scanning electron microscope (SEM), and equivalent circle diameters of the metal particles 10 included in the section are measured. Then, the maximum value of the measured equivalent circle diameters is identified as a maximum particle size D_{MAX} (unit: μm) of the soft magnetic powder 1. Next, as illustrated in FIG. 3A, the section under observation is divided using a regular-interval grid G. The regular-interval grid G is an imaginary division defined by a combination of vertical lines and horizontal lines spaced at regular intervals and is shown in dashed lines in FIG. 3A. The regular-interval grid G has a grid width that is two times the maximum particle size D_{MAX}. That is, the section of the magnetic core 2 is divided by the regular-interval grid G into square regions 20 each having 2D_{MAX}-long sides and an area of (2D_{MAX})². Each square region 20 defined by the regular-interval grid G is an analysis unit of the area ratio. The number of vertical lines and the number of horizontal lines of the regular-interval grid G may be different but are preferably approximately the same.

FIG. 3B is an example schematic view of one square region 20. After the section of the magnetic core 2 is divided, an area ratio xᵢ of the soft magnetic powder 1 in each square region 20 is measured. The area ratio xᵢ (unit: %) of the soft magnetic powder 1 in each square region 20 is represented by the ratio (αᵢ/Aᵢ) of αᵢ to Aᵢ, where Aᵢ denotes the area of the square region 20 (i.e., Aᵢ=(2D_{MAX})²) and αᵢ denotes the total area of the metal particles 10 included in the square region 20. The number of square regions 20 whose area ratio xᵢ is measured is at least thirty or is preferably one hundred or more. Measurement of the area ratio xᵢ of the soft magnetic powder 1 in each square region 20 using the above method can identify the area ratio distribution of the soft magnetic powder 1 of the magnetic core 2. The above analysis is performed using image analysis software.

In the magnetic core 2 of the present embodiment, the area ratio xᵢ averages 75% or more and 90% or less (average area ratio x_{A}). The average area ratio x_{A} is equivalent to the average packing density of the soft magnetic powder 1 of the magnetic core 2. The average area ratio x_{A} may be calculated by dividing the sum of αᵢ/Aᵢ by the number of samples (i.e., the number of square regions 20) or may be calculated by dividing the sum of αᵢ by the sum of Aᵢ.

In the magnetic core 2, skewness Sₖ (no unit) of the area ratio distribution of the soft magnetic powder 1 is 0.01 or more in absolute value (i.e., |0.01|≤Sₖ). The skewness Sₖ is an index of bilateral symmetry of the area ratio distribution and indicates a statistic representing how much the area ratio distribution is skewed from a normal distribution. Specifically, the skewness Sₖ of the area ratio distribution is calculated using the following formula 1.

$$\begin{matrix}Formula 1 & \\ {S}_{k} = \frac{n}{( n - 1 ) ( n - 2 )} {{\sum }^{n}}_{i = 1} {( \frac{{x}_{i} - {x}_{A}}{σ} )}^{3} & ( 1 )\end{matrix}$$

In the above formula 1, xᵢ denotes the area ratio of the soft magnetic powder 1 in each square region 20; x_{A} denotes the average area ratio of the soft magnetic powder 1; σ denotes the standard deviation of the area ratio; and n denotes the number of samples (i.e., the number of square regions 20).

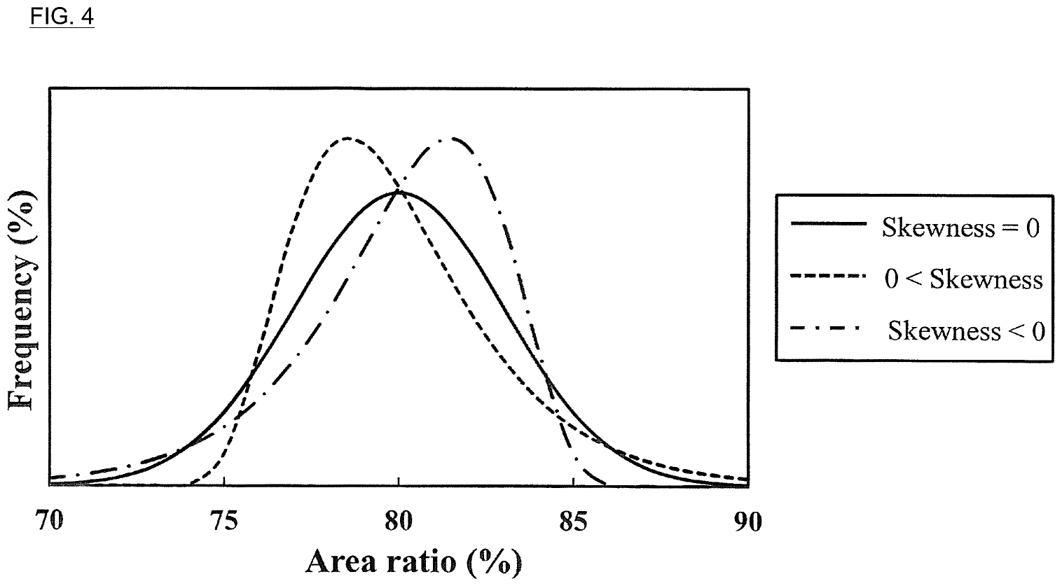

FIG. 4 is a graph of an example area ratio distribution of the soft magnetic powder 1. The horizontal axis of the graph represents the area ratio (i.e., packing density), and the vertical axis of the graph represents frequency. The right side of the graph along the horizontal axis is referred to as a “tightly packed side”, and the left side of the graph is referred to as a “loosely packed side”. In FIG. 4, three types of distribution curves are illustrated as area ratio distributions of the soft magnetic powder 1, and the average area ratio x_{A} of each of these distribution curves is 80%. Among the three types of distribution curves illustrated in FIG. 4, the distribution curve in a solid line is the normal distribution. The normal distribution has a bilaterally symmetrical shape with a maximum point as a center. When the area ratio distribution of the soft magnetic powder 1 follows the normal distribution, the skewness Sₖ is 0.

The distribution curve in a dashed-and-dotted line in FIG. 4 is an example area ratio distribution with a negative skewness Sₖ. When the skewness Sₖ is negative, the area ratio is distributed more widely on the loosely packed side than on the tightly packed side from a maximum point. In other words, the skewness Sₖ is negative when the tail of the area ratio distribution on the loosely packed side is longer than the tail of the area ratio distribution on the tightly packed side. Controlling the skewness Sₖ to −0.01 or less for the magnetic core 2 satisfying 75%≤x_{A}≤90% can improve DC superimposition characteristics more than when the skewness satisfies −0.01<Sₖ<0.01.

By contrast, the distribution curve in a dotted line is an example area ratio distribution with a positive skewness Sₖ. When the skewness Sₖ is positive, the area ratio is distributed more widely on the tightly packed side than on the loosely packed side from a maximum point. In other words, the skewness Sₖ is positive when the tail of the area ratio distribution on the tightly packed side is longer than the tail of the area ratio distribution on the loosely packed side. Setting the skewness Sₖ to 0.01 or more for the magnetic core 2 satisfying 75%≤x_{A}≤90% can increase permeability more than when the skewness Sₖ is 0. When a magnetic core is designed, the average packing density of a soft magnetic powder is determined so that desired permeability can be attained. Controlling the skewness Sₖ of the magnetic core 2 of the present embodiment to 0.01 or more can reduce the average area ratio x_{A} (average packing density) required to attain the desired permeability more than when −0.01<Sₖ<0.01 is satisfied. That is, because high permeability can be attained at a low packing density, contact between the metal particles 10 can be prevented, which can prevent local magnetic saturation. As a result, DC superimposition characteristics can be improved.

As described above, the skewness Sₖ may be negative or positive, and controlling the absolute value of the skewness Sₖ to 0.01 or more can improve DC superimposition characteristics. In terms of further improving DC superimposition characteristics, the absolute value of the skewness Sₖ is preferably 0.05 or more or is more preferably 0.10 or more. The upper limit of the absolute value of the skewness Sₖ is not limited. However, the absolute value of the skewness Sₖ is, for example, preferably 10.00 or less or more preferably 5.00 or less. In terms of ensuring compatibility between high permeability and good DC superimposition characteristics more suitably, the skewness Sₖ is preferably negative (e.g., −10.00 or more and −0.01 or less).

An example method of manufacturing the magnetic core 2 according to the present embodiment is described below.

First, the soft magnetic powder 1 is prepared. A method of manufacturing the soft magnetic powder 1 is not limited. A method suitable for a desired particle composition is employed. For example, an atomization method (e.g., a water atomization method or a gas atomization method) may be used to manufacture the soft magnetic powder. Alternatively, a CVD method involving at least one selected from vaporization, reduction, and thermal decomposition of a metal salt may be used to manufacture the soft magnetic powder. Alternatively, a single-roll method or the like may be used to prepare a soft magnetic metal ribbon, and the soft magnetic metal ribbon may be pulverized to manufacture the soft magnetic powder. Other than these, an electrolytic method or a carbonyl method may be used to manufacture the soft magnetic powder.

When the soft magnetic powder having an amorphous structure or a nanocrystalline structure is manufactured, the gas atomization method or the single-roll method is preferably employed among the above methods of manufacturing the powder. The soft magnetic powder having a nanocrystalline structure may also be manufactured by performing a heat treatment of controlling the crystal structure for a soft magnetic powder having an amorphous structure prepared using the gas atomization method or the single-roll method.

When the soft magnetic powder 1 including two or more types of particle groups is manufactured, raw material powders of the respective particle groups are prepared. For example, when the soft magnetic powder 1 including the large particles 10a and the small particles 10b is manufactured, a large-size powder made up of the large particles 10a and a small-size powder made up of the small particles 10b are prepared and are mixed at a desired ratio. Alternatively, when the soft magnetic powder 1 including the large particles 10a, the medium particles 10c, and the small particles 10b is manufactured, the large-size powder, the small-size powder, and a medium-size powder made up of the medium particles 10c are prepared and are mixed at a desired ratio. The ratio of the large-size powder, the medium-size powder, and the small-size powder is not limited. For example, out of 100 wt % of the soft magnetic powder, the large-size powder accounts for preferably 50 wt % or more and 90 wt % or less, or more preferably 60 wt % or more and 80 wt % or less. The medium-size powder and the small-size powder preferably account for 5 wt % or more and 30 wt % or less each.

When the insulation films are provided on the particle surfaces of the soft magnetic powder 1, a film formation treatment is performed for the soft magnetic powder 1. A method of performing the film formation treatment is not limited. A film formation treatment suitable for the insulation film type is selected. Examples of film formation treatments include a heat treatment, a phosphate treatment, a mechanochemical surface treatment, mechanical alloying, a silane coupling treatment, and hydrothermal synthesis. When the soft magnetic powder 1 having two or more types of powders (e.g., the large-size powder, the medium-size powder, and the small-size powder) being mixed is manufactured, the film formation treatment may be performed for the soft magnetic powder 1 after mixing or for each powder individually before mixing.

Next, using the soft magnetic powder 1, granules are manufactured, which are raw material of the magnetic core 2. First, resin raw materials (e.g., thermosetting resin and hardener) are added to an organic solvent (e.g., acetone or ethanol) to prepare a resin solution. Then, the soft magnetic powder 1 is added to the resin solution, and they are kneaded. At this time, various kneaders (e.g., a kneader, a planetary mixer, a rotation/revolution mixer, or a twin screw extruder) are used for kneading of the soft magnetic powder 1 and the resin solution; and a modifier, a preservative, a dispersant, a non-magnetic powder, or the like may be added to the kneaded material. After kneading, the organic solvent is volatilized to give granules.

The mix ratio of the soft magnetic powder 1 to the resin raw materials in the above kneading step is not limited. For example, the soft magnetic powder 1 and the resin raw materials are preferably weighed so that there are 1 part by weight or more and 5 parts by weight or less of the resin 3 after hardening with respect to 100 parts by weight of the soft magnetic powder. When two or more types of raw material powders (e.g., the large-size powder, the medium-size powder, and the small-size powder) are used, these raw material powders may be mixed in advance and the resulting mixed powder may be added to the resin solution; or the raw material powders may be added to the resin solution without being mixed and may be mixed in the kneading step.

The granules may have any dimensions and any shapes. For example, the granules preferably have a particulate shape with a size of 0.02 mm or more and 0.5 mm or less and preferably have an average size of 0.05 mm or more and 0.2 mm or less. To control the dimensions of the granules within the above range, sieve classification is preferably carried out after the kneading step. Conditions of sieve classification are not limited. For example, classification of the granules resulting from the kneading step using sieves with an opening of 20 μm to 500 μm can control a particle size distribution of the granules to the range of 0.02 mm or more and 0.50 mm or less and can improve kurtosis of the particle size distribution. In the present embodiment, the granules after sieve classification are referred to as first granules.

When a magnetic core is manufactured using only the first granules as raw material, the area ratio distribution of the soft magnetic powder of the magnetic core follows the normal distribution, and the skewness Sₖ of the area ratio distribution is approximated to 0 (specifically, −0.01<Sₖ<0.01). The skewness of the area ratio distribution of the soft magnetic powder 1 can be controlled based on a distribution of specific gravity (unit: g/cm³) of the granules. The specific gravity of each granule has a correlation with the percentage of the soft magnetic powder in the granule. A granule with high specific gravity has higher percentage of the soft magnetic powder, whereas a granule with low specific gravity has lower percentage of the soft magnetic powder. For example, when granules with high specific gravity are removed from raw material granules to increase the percentage of granules with low specific gravity, the skewness of the area ratio distribution can be controlled to −0.01 or less. By contrast, when granules with low specific gravity are removed from raw material granules to increase the percentage of granules with high specific gravity, the skewness of the area ratio distribution can be controlled to 0.01 or more. Thus, in the present embodiment, in order to control the skewness of the area ratio distribution to a desired value, air flow classification is further carried out after sieve classification to prepare second granules.

Manufacturing conditions of the second granules are not limited. For example, the granules are classified using a finely meshed sieve with an opening of 20 μm to 100 μm to extract those having small dimensions. Then, air flow classification is further carried out for the extracted granules to remove those with high specific gravity, thereby extracting the second granules with low specific gravity. Using such second granules with low specific gravity can control the skewness Sₖ to −0.01 or less. By contrast, in order to control the skewness Sₖ to 0.01 or more, the second granules with high specific gravity are extracted. For example, the granules are classified using a coarsely meshed sieve with an opening of 200 μm to 500 μm. Then, air flow classification is further carried out for the granules after sieve classification, thereby extracting the second granules with high specific gravity.

The skewness Sₖ of the area ratio distribution can be controlled according to conditions of sieve classification and air flow classification. Also, the second granules, which have gone through the above classification step, and the first granules, which have not gone through air flow classification, are preferably mixed for use; and according to the mix ratio of the first granules to the second granules, the skewness Sₖ can be controlled with higher accuracy.

Next, a mold is filled with the second granules or a mixture (mixed granules) of the first granules and the second granules, and compression molding is performed, to manufacture a compact body. At this time, the molding pressure is not limited and may be, for example, 9.8 MPa or more and 1.2×10³ MPa or less (0.1 t/cm² or more and 12 t/cm² or less). While the average area ratio x_{A} (i.e., average packing density) of the soft magnetic powder 1 of the magnetic core 2 can be controlled according to the percentage of the resin 3 (the mix ratio of the resin raw materials), the average area ratio x_{A} can also be controlled according to the molding pressure. When a thermosetting resin is included as the resin 3, the compact body resulting from molding is heated at 100° C. to 200° C. for 1 hour to 5 hours to harden the thermosetting resin. The above steps give the magnetic core 2 having a section illustrated in FIG. 1.

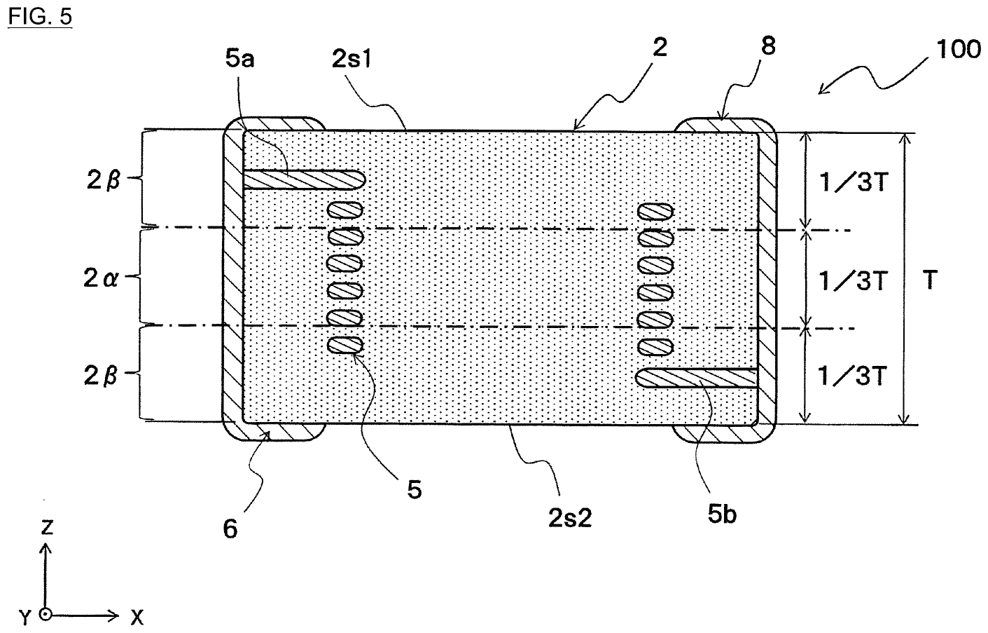

The magnetic core 2 according to the present embodiment can be applied to various magnetic components, such as inductors, transformers, and choke coils. For example, a magnetic component 100 illustrated in FIG. 5 is an example magnetic component including the magnetic core 2.

The magnetic component 100 includes a coil 5 and an element body composed of the magnetic core 2. The coil 5 is embedded in the magnetic core 2. The coil 5 has a structure in which a conductor is spirally wound. The number of windings of the conductor or the method of winding is not limited. The conductor of the coil 5 may have any shape and any dimensions. A surface of the conductor is preferably covered with an insulation film. The structure of the coil 5 is not limited to the one illustrated in FIG. 5; and the magnetic component 100 may include, as a coil, a flexible substrate having a coil pattern printed.

End portions 5a and 5b of the conductor of the coil 5 are drawn out to end surfaces of the magnetic core 2. On the end surfaces of the magnetic core 2, a pair of external electrodes 6 and 8 are formed. The external electrodes 6 and 8 are electrically connected to the end portions 5a and 5b of the coil 5, respectively.

FIG. 5 illustrates a section of the magnetic component 100 along a coil axis. The coil axis refers to a center axis penetrating, along an inner circumferential surface of the coil 5, a center of a region surrounded by the inner circumferential surface. The X-axis, the Y-axis, and the Z-axis illustrated in FIG. 5 are perpendicular to each other, and the Z-axis is substantially parallel to the coil axis. Of two main surfaces of the magnetic core 2 of the magnetic component 100 that are perpendicular to the coil axis, one main surface located above the other main surface in the Z-axis direction is referred to as an upper surface 2s1, and the other main surface located below the former main surface in the Z-axis direction is referred to as a lower surface 2s2. The height of the magnetic core 2 in the Z-axis direction is denoted by T.

When the area ratio distribution of the soft magnetic powder 1 is identified in a section of the magnetic component 100, the location at which a sectional image is obtained, i.e., the location of a region subject to an area ratio analysis using the regular-interval grid G, is not limited. For example, a section resulting from cutting the magnetic core 2 along the coil axis as illustrated in FIG. 5 is preferably analyzed. Also, preferred is dividing the section, which runs along the coil axis, of the magnetic core 2 into a center portion 2α and outer portions 2β as illustrated in FIG. 5 to measure the area ratio of the soft magnetic powder 1.

Specifically, among three regions defined by trisecting the section illustrated in FIG. 5 along the coil axis, one region at the center is defined as the center portion 2α, and the regions located outwards from the center portion 2α are defined as the outer portions 2β. The phrase “trisecting . . . along the coil axis” indicates dividing the section of the magnetic core 2 by drawing imaginary lines orthogonal to the coil axis as shown in dashed-and-dotted lines at a location deep by ⅓T from the upper surface 2s1 of the magnetic core 2 and a location deep by ⅓T from the lower surface 2s2 of the magnetic core 2. At least a part of the center portion 2α is preferably included in the analysis regions of the area ratio. Also, more preferred is setting the analysis regions in both the center portion 2α and at least one of the outer portions 2β using the regular-interval grid G and combining analysis results of the center portion 2α and analysis results of the at least one of the outer portions 2β to identify the area ratio distribution, average area ratio x_{A}, and skewness Sₖ.

When the area ratio distribution of the soft magnetic powder 1 is individually identified in the center portion 2α and in the at least one of the outer portions 2β, at least the area ratio distribution of the center portion 2α or the area ratio distribution of the at least one of the outer portions 2B preferably satisfies |0.01|≤Sₖ; the area ratio distribution of the center portion 2α more preferably satisfies |0.01|≤Sₖ; or both the area ratio distribution of the center portion 2α and the area ratio distribution of the at least one of the outer portions 2β most preferably satisfy |0.01|≤Sₖ. The skewness Sₖ may be the same between the center portion 2α and the at least one of the outer portions 2β or may be different therebetween. The average area ratio x_{A} (average packing density) may be the same between the center portion 2α and the at least one of the outer portions 2β or may be different therebetween.

In an analysis of the area ratio distribution, the section of the magnetic core 2 may be divided into an inner axial region, which is surrounded by the inner circumferential surface of the coil 5, and an outer region, which is a region other than the inner axial region. Also in this case, preferred is setting the analysis regions in both the inner axial region and the outer region using the regular-interval grid G and combining analysis results of the inner axial region and analysis results of the outer region to identify the area ratio distribution, average area ratio x_{A}, and skewness Sₖ. When the area ratio distribution of the soft magnetic powder 1 is individually identified in the inner axial region and in the outer region, at least the area ratio distribution of the inner axial region or the area ratio distribution of the outer region preferably satisfies |0.01|≤Sₖ; the area ratio distribution of the inner axial region more preferably satisfies |0.01|≤Sₖ; or both the area ratio distribution of the inner axial region and the area ratio distribution of the outer region most preferably satisfy |0.01|≤Sₖ. The skewness Sₖ may be the same between the inner axial region and the outer region or may be different therebetween. The average area ratio x_{A} (average packing density) may be the same between the inner axial region and the outer region or may be different therebetween.

As for the magnetic component 100, when the area ratio distribution of the soft magnetic powder 1 is identified using a section of the magnetic core 2 having the coil 5 embedded, any square region 20 including the coil 5 is not subject to analyses.

Usage of the magnetic component 100 illustrated in FIG. 5 is not limited. The magnetic component 100 can be suitably used, for example, as a power inductor included in a power supply circuit. A magnetic component including the magnetic core 2 is not limited to the aspect of FIG. 5. The magnetic component may include, for example, the magnetic core 2 having a predetermined shape and having a wire wound around a surface of the magnetic core 2.

### Summary of Embodiment

The average area ratio x_{A} of the soft magnetic powder 1 in a section of the magnetic core 2 of the present embodiment is 75% or more and 90% or less; and the skewness Sₖ of the area ratio distribution of the soft magnetic powder 1 is 0.01 or more in absolute value.

Having the above characteristics, the magnetic core 2 can have more improved DC superimposition characteristics than a conventional magnetic core. More specifically, with a skewness Sₖ of −0.01 or less, the DC superimposition rated current of the magnetic core 2 can be higher than that of a magnetic core having an area ratio distribution following the normal distribution (a magnetic core satisfying −0.01<Sₖ<0.01), allowing excellent DC superimposition characteristics. Also, with a skewness Sₖ of 0.01 or more, permeability that is higher than that of the magnetic core having an area ratio distribution following the normal distribution can be attained, allowing reduction of the packing density required to attain desired permeability. As a result, the DC superimposition characteristics can be improved compared to the conventional magnetic core.

The embodiment of the present disclosure has been described above; however, the present disclosure is not limited to the embodiment described above and can be modified variously without departing from the gist of the present disclosure.

For example, a plurality of magnetic cores 2 may be combined to manufacture a magnetic component. Also, a method of manufacturing the magnetic core 2 is not limited to the method described in the above embodiment; and the magnetic core 2 may be manufactured by two-stage compression. In a method of manufacturing the magnetic core 2 using two-stage compression, for example, after the second granules or the mixed granules are preliminarily compressed to prepare preliminary compact bodies, these preliminary compact bodies are combined and compressed to give the magnetic core 2.

### EXAMPLES

Hereinafter, the present disclosure is described based on further detailed examples; however, the present disclosure is not limited to these examples.

### Experiment 1

### Sample Nos. A6 to A15

Magnetic cores according to Sample Nos. A6 to A15 shown in Table 1 were manufactured using the following procedure.

First, as raw material powders of a soft magnetic powder, large particles and small particles were prepared. Specifically, a rapid gas atomization method was used to manufacture the large particles having an amorphous structure. The large particles had an average composition of 57.5 at % Fe, 24.6 at % Co, 11 at % B, 3 at % P, 3 at % Si, and 1 at % Cr and had an average particle size of 25 μm. The large particles were subject to a mechanochemical film formation treatment to form insulation films having a P—Zn—Na—Al—O composition. The insulation films had an average thickness of 20 nm. By contrast, as the small particles, an Fe powder having an average particle size of 1 μm and a crystalline structure was prepared.

Next, as resin raw materials, an epoxy resin and an imide resin (hardener) were prepared; and these resin raw materials were added to acetone to prepare a resin solution. Then, the resin solution, the large particles, and the small particles were kneaded; and the resulting kneaded material was dried under predetermined conditions to have acetone volatilized to prepare granules. In this kneading step, out of 100 wt % of the total of the large particles and the small particles, the large particles accounted for 80 wt %, and the small particles accounted for 20 wt %. Also, the soft magnetic powder (the large particles and the small particles) and the resin raw materials were weighed so that there were 2.5 parts by weight of the resin component after hardening with respect to 100 parts by weight of the soft magnetic powder.

Next, the granules resulting from the kneading step were classified using sieves with an opening of 20 μm to 500 μm to prepare first granules. For Sample Nos. A6 to A10, the granules resulting from the kneading step were classified using a sieve with an opening of 20 μm to 100 μm; and air flow classification was further carried out for the granules after sieve classification to extract second granules with low specific gravity. For Sample Nos. A6 to A10, the first granules, which did not go through air flow classification, and the second granules, which went through air flow classification, were mixed at a ratio such that the area ratio distribution had a skewness Sₖ of −0.50, to prepare mixed granules.

By contrast, for Sample Nos. A11 to A15, the granules resulting from the kneading step were classified using a sieve with an opening of 200 μm to 500 μm; and air flow classification was further carried out for the granules after sieve classification to extract second granules with high specific gravity. For Sample Nos. A11 to A15, the first granules, which did not go through air flow classification, and the second granules, which went through air flow classification, were mixed at a ratio such that the area ratio distribution had a skewness Sₖ of 0.50, to prepare mixed granules.

Next, a mold was filled with the mixed granules, and pressure was applied, to prepare compact bodies having a toroidal shape. The molding pressure at this time was 9.8 MPa or more and 1.2×10³ MPa or less, thereby controlling the average area ratio x_{A} (average packing density) of the soft magnetic powder of each sample as shown in Table 1. The compact bodies were subject to a heating treatment at 180° C. for 60 minutes to harden the epoxy resin in the compact bodies to prepare the magnetic cores having a toroidal shape (outer diameter 11 mm, inner diameter 6.5 mm, thickness 2.5 mm).

### Sample Nos. A1 to A5

For Sample Nos. A1 to A5, first granules were manufactured using the same soft magnetic powder and the same resin raw materials as Sample Nos. A6 to A15 and under the same conditions as Sample Nos. A6 to A15. However, for Sample Nos. A1 to A5, only the first granules, which did not go through air flow classification, were used instead of the mix granules to manufacture magnetic cores. That is, for Sample Nos. A1 to A5, a mold was filled with only the first granules to prepare compact bodies, and then the epoxy resin in the compact bodies was hardened to prepare the magnetic cores having a toroidal shape (outer diameter 11 mm, inner diameter 6.5 mm, thickness 2.5 mm). Similarly to Sample Nos. A6 to A15, the molding pressure for Sample Nos. A1 to A5 was 9.8 MPa or more and 1.2×10³ MPa or less, thereby controlling the average area ratio x_{A} (average packing density) as shown in Table 1.

The manufactured magnetic core of each sample of Experiment 1 was subject to the following evaluation.

### Sectional Analysis of Magnetic Core

A section of the magnetic core was observed using a SEM, and the area ratio distribution of the soft magnetic powder was analyzed using image analysis software (NanoHunter NS2K-Pro manufactured by Nanosystem Corporation). Specifically, first, equivalent circle diameters of metal particles included in the section of the magnetic core were measured, and the maximum particle size D_{MAX} (maximum value of the equivalent circle diameters) of the soft magnetic powder was identified. The section of the magnetic core was then divided into one hundred square regions using a regular-interval grid having a grid width that was two times the maximum particle size D_{MAX}. Then, the total area of the metal particles included in each square region having an area of (2D_{MAX})² was measured to calculate the area ratio xᵢ of the soft magnetic powder in the square region. Based on these measurement results, the average area ratio x_{A} of the soft magnetic powder of the magnetic core and the skewness Sₖ of the area ratio distribution were calculated.

Regarding the magnetic cores of Sample Nos. A1 to A5 for which only the first granules were used, the area ratio distribution of the soft magnetic powder followed a normal distribution and had a skewness Sₖ of 0.00. By contrast, regarding the magnetic cores of Sample Nos. A6 to A10 for which the mixed granules including the first granules and the second granules with low specific gravity were used, the area ratio distribution of the soft magnetic powder had a skewness Sₖ of −0.50. Regarding the magnetic cores of Sample Nos. A11 to A15 for which the mixed granules including the first granules and the second granules with high specific gravity were used, the area ratio distribution of the soft magnetic powder had a skewness Sₖ of 0.50.

### Evaluation of Magnetic Core Properties

A copper wire (UEW wire) having a polyurethane insulation film was wound around the magnetic core having the toroidal shape. Then, inductance L₀ of the magnetic core at a frequency of 1 MHz was measured using an LCR meter (4284A manufactured by Agilent Technologies); and based on the inductance L₀, initial permeability μ1 (no unit) of the magnetic core was calculated. In Experiment 1, initial permeability μ1 of 20 or more was defined as good.

A direct current was applied to the magnetic core having the UEW wire wound starting from 0 A at a constant increase rate, and variance of inductance at that time was measured. The value of a direct current at which inductance L was reduced by 10% from the inductance L₀ at a direct current of 0 A (i.e., the value of a direct current at which L/L₀=90% was reached) was identified as a DC superimposition rated current (Isat) (unit: A).

Table 1 shows evaluation results of each sample of Experiment 1.

TABLE 1

| | | Area ratio distribution | | | |
|---|---|---|---|---|---|
| | | of soft magnetic | | | |
| | Example/ | powder | | Properties | |
| Sample | Comparative | Average | Skewness | μi | Isat |
| No. | Example | (%) | (−) | (−) | (A) |
| A1 | Comparative | 70.4 | 0.00 | 19 | 11.6 |
| | Example | | | | |
| A2 | Comparative | 75.3 | 0.00 | 22 | 11.0 |
| | Example | | | | |
| A3 | Comparative | 80.4 | 0.00 | 27 | 10.1 |
| | Example | | | | |
| A4 | Comparative | 85.0 | 0.00 | 30 | 9.4 |
| | Example | | | | |
| A5 | Comparative | 89.4 | 0.00 | 34 | 8.2 |
| | Example | | | | |
| A6 | Comparative | 70.1 | −0.50 | 18 | 12.5 |
| | Example | | | | |
| A7 | Example | 75.0 | −0.50 | 23 | 12.3 |
| A8 | Example | 80.2 | −0.50 | 29 | 11.4 |
| A9 | Example | 85.2 | −0.50 | 33 | 10.5 |
| A10 | Example | 89.6 | −0.50 | 36 | 10.0 |
| A11 | Comparative | 70.1 | 0.50 | 19 | 11.5 |
| | Example | | | | |
| A12 | Example | 75.0 | 0.50 | 29 | 10.9 |
| A13 | Example | 80.2 | 0.50 | 35 | 9.8 |
| A14 | Example | 85.2 | 0.50 | 38 | 9.4 |
| A15 | Example | 89.6 | 0.50 | 42 | 8.8 |

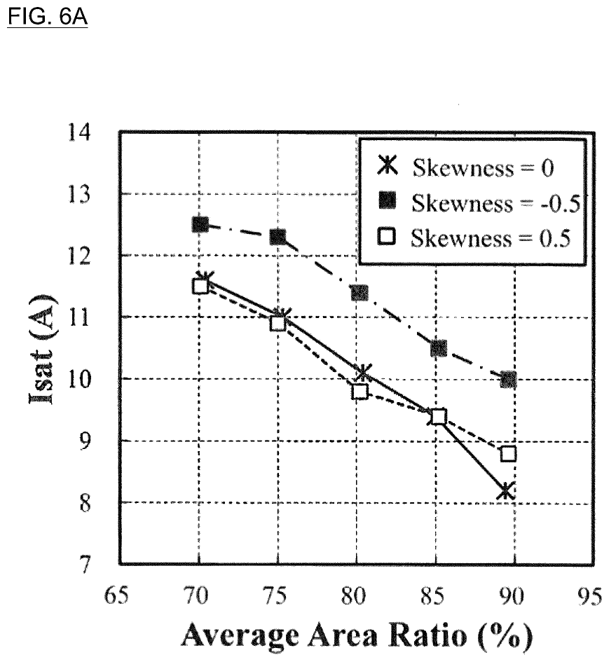

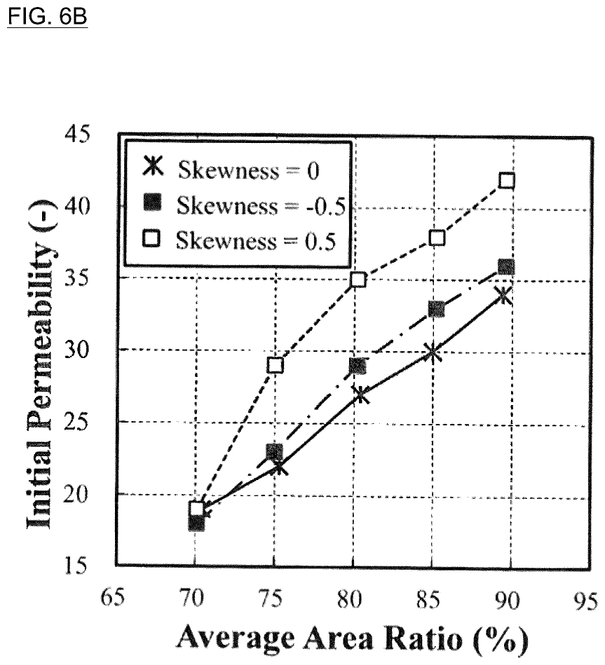

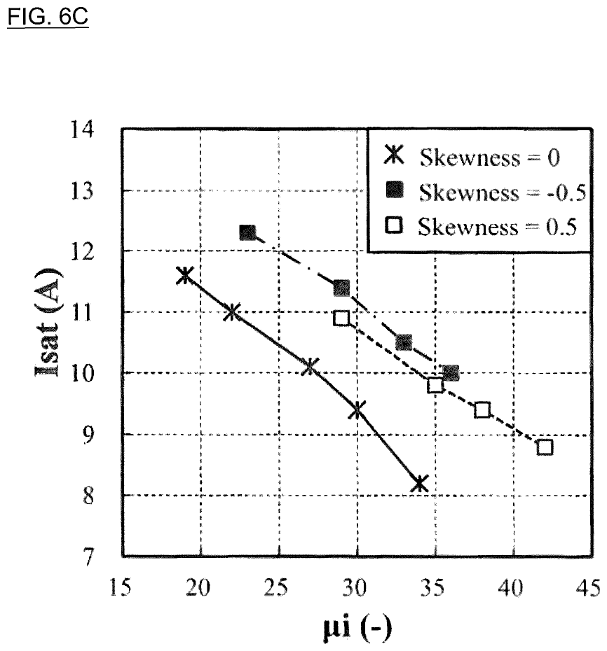

As shown in Table 1, in samples having an average area ratio x_{A} of the soft magnetic powder of 75% or more (Sample Nos. A2 to A5, A7 to A10, and A12 to A15), μi was 20 or more to ensure high permeability. As for DC superimposition characteristics, the DC superimposition rated current tended to decrease along with the increase in the average area ratio x_{A}. It was found that Examples having a skewness Sₖ of −0.50 (Sample Nos. A7 to A10) and Examples having a skewness Sₖ of 0.50 (Sample Nos. A12 to A15) attained better DC superimposition characteristics than Comparative Examples having a skewness Sₖ of 0.00 (Sample Nos. A2 to A5) while high permeability was ensured. Effects of improving DC superimposition characteristics are described below in detail with reference to FIGS. 6A to 6B.

FIG. 6A is a graph of a relationship between the average area ratio x_{A} (average packing density) and Isat of the soft magnetic powders of the magnetic cores. The horizontal axis of FIG. 6A represents the average area ratio x_{A}, and the vertical axis of FIG. 6A represents Isat. Evaluation results of Sample Nos. A1 to A15 shown in Table 1 are plotted in FIG. 6A. As illustrated in FIG. 6A, Examples having a skewness Sₖ of −0.5 had higher Isat than Comparative Examples, i.e., had improved DC superimposition characteristics.

By contrast, FIG. 6B is a graph of a relationship between the average area ratio x_{A} (average packing density) and μi of the soft magnetic powders of the magnetic cores. The horizontal axis of FIG. 6B represents the average area ratio x_{A}, and the vertical axis of FIG. 6B represents μi. Evaluation results of Sample Nos. A1 to A15 shown in Table 1 are plotted in FIG. 6B. For the range of the average area ratio x_{A} of 75% or more and 90% or less, μi of Examples having a skewness Sₖ of 0.50 was higher than that of Comparative Examples.

In designing a magnetic core included in a magnetic component, first, permeability required to attain desired inductance is determined, and average packing density of the soft magnetic powder required to attain that permeability is determined. DC superimposition characteristics are characteristics realized by the determined average packing density. Because Examples having a skewness Sₖ of 0.50 had higher permeability than Comparative Examples, it was possible to reduce the average packing density required to attain the desired permeability. For example, while the average packing density of the soft magnetic powder was required to be set at about 85% in order to attain μi=30 for Comparative Examples having a skewness Sₖ of 0.00, it was possible to attain μi=30 at an average packing density of about 76% for Examples having a skewness Sₖ of 0.50. In this manner, because the average packing density was able to be reduced, Examples having a skewness Sₖ of 0.50 were able to have better DC superimposition characteristics than Comparative Examples at predetermined permeability.

FIG. 6C is a graph of a relationship between μi and Isat, and evaluation results of each sample shown in Table 1 are plotted in FIG. 6C. As is obvious from FIG. 6C, whereas Comparative Examples having a skewness Sₖ of 0.00 had an Isat of about 9.4 A at μi=30, Examples having a skewness Sₖ of 0.50 had an Isat of about 10.7 A at μi=30 and were able to have better DC superimposition characteristics than Comparative Examples. From FIG. 6C, it can be determined that the closer the plotted evaluation results are to the upper right of the graph, the better the magnetic properties. According to FIG. 6C, it was found that Examples having a skewness Sₖ of −0.50 and Examples having a skewness Sₖ of 0.50 were able to have high permeability and excellent DC superimposition characteristics compatible with each other.

### Experiment 2

In Experiment 2, to examine the effects of improving DC superimposition characteristics by skewness Sₖ in more detail, magnetic cores shown in Tables 2 and 3 were manufactured. As shown in Tables 2 and 3, four magnetic cores with different average area ratios at predetermined skewness Sₖ were manufactured in Experiment 2.

### Sample Nos. B1 to B28

Specifically, for Sample Nos. B1 to B28 shown in Table 2, first granules were manufactured using the same soft magnetic powder and the same resin raw materials as Experiment 1 and under the same conditions as Experiment 1. The granules resulting from the kneading step were classified using sieves with an opening of 20 μm to 100 μm, and air flow classification was further carried out for the granules after sieve classification to extract second granules with low specific gravity.

For Sample Nos. B1 to B24 shown in Table 2, mixed granules including the first granules and the second granules with low specific gravity were used to manufacture the magnetic cores having a toroidal shape. At that time, the mix ratio of the first granules to the second granules was determined so that the skewness Sₖ of the area ratio distribution of the soft magnetic powder was as shown in Table 2. For Sample Nos. B25 to B28 shown in Table 2, only the second granules with low specific gravity were used to manufacture the magnetic cores having a toroidal shape.

As described above, in Sample Nos. B1 to B28, while the mix ratio of the first granules to the second granules was different from that of Sample Nos. A6 to A10 of Experiment 1, other conditions, such as the specifications of the large particles and the small particles, the ratio of the large particles to the small particles, the ratio of the soft magnetic powder to the resin, and the dimensions of the magnetic cores having the toroidal shape, were similar to those of Experiment 1. Similarly to Experiment 1, in Sample Nos. B1 to B28, the average area ratio x_{A} (average packing density) was controlled as shown in Table 2 by the molding pressure at which the magnetic cores were manufactured.

### Sample Nos. C1 to C28

For Sample Nos. C1 to C28 shown in Table 3, first granules were manufactured using the same soft magnetic powder and the same resin raw materials as Experiment 1 and under the same conditions as Experiment 1. The granules resulting from the kneading step were classified using sieves with an opening of 200 μm to 500 μm, and air flow classification was further carried out for the granules after sieve classification to extract second granules with high specific gravity.

For Sample Nos. C1 to C24, mixed granules including the first granules and the second granules with high specific gravity were used to manufacture the magnetic cores having a toroidal shape. At that time, the mix ratio of the first granules to the second granules was determined so that the skewness Sₖ of the area ratio distribution of the soft magnetic powder was as shown in Table 3. For Sample Nos. C25 to C28 shown in Table 3, only the second granules with high specific gravity were used to manufacture the magnetic cores having a toroidal shape.

As described above, in Sample Nos. C1 to C28, while the mix ratio of the first granules to the second granules was different from that of Sample Nos. A11 to A15 of Experiment 1, other conditions, such as the specifications of the large particles and the small particles, the ratio of the large particles to the small particles, the ratio of the soft magnetic powder to the resin, and the dimensions of the magnetic cores having the toroidal shape, were similar to those of Experiment 1. Similarly to Experiment 1, in Sample Nos. C1 to C28, the average area ratio x_{A} (average packing density) was controlled as shown in Table 3 by the molding pressure at which the magnetic cores were manufactured.

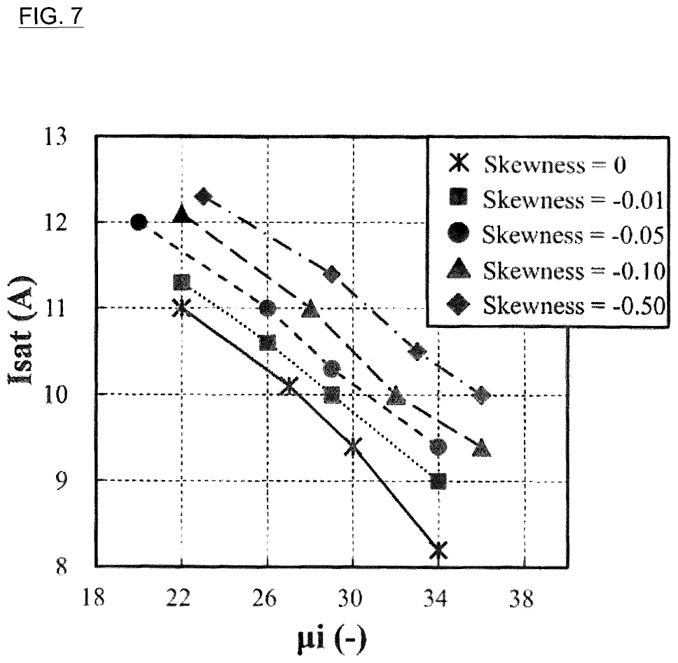

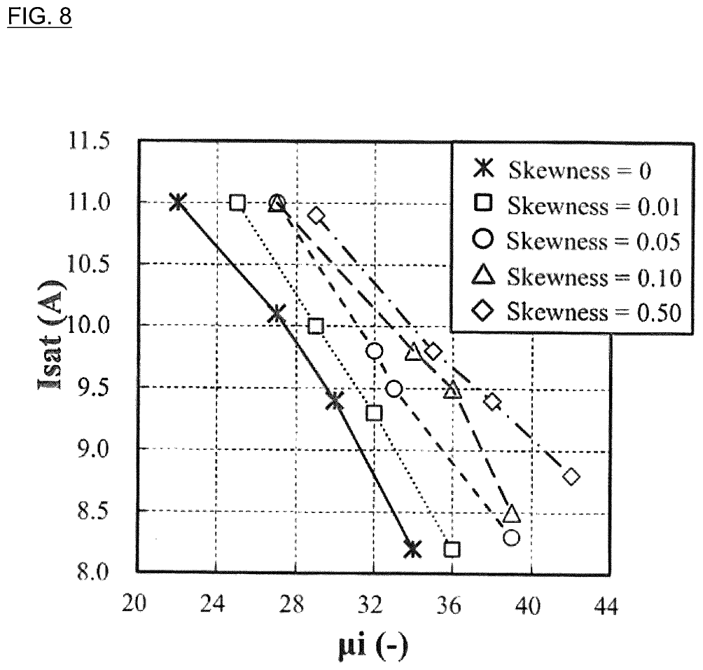

The average area ratio x_{A}, skewness Sₖ, μi, and Isat of each sample of Experiment 2 were measured as in Experiment 1. Tables 2 and 3 show the evaluation results of each sample. Table 2 shows the evaluation results of Examples having a skewness Sₖ of −0.01 or less. Table 3 shows the evaluation results of Examples having a skewness Sₖ of 0.01 or more. FIG. 7 is a graph of a relationship between μi and Isat, and part (skewness Sₖ=0.00, −0.01, −0.05, −0.10, −0.50) of the evaluation results shown in Table 2 is plotted in FIG. 7. FIG. 8 is a graph of a relationship between μi and Isat, and part (skewness Sₖ=0.00, 0.01, 0.05, 0.10, 0.50) of the evaluation results shown in Table 3 is plotted in FIG. 8.

In Experiment 2, using the evaluation results of the four samples at each skewness Sₖ, Isat in the case of setting μi to 30 at that skewness Sₖ was calculated. Specifically, the evaluation results of the four samples at each skewness Sₖ were plotted in a graph of a relationship between μi and Isat as in FIGS. 7 and 8, and an approximate straight line based on these plotted results was found using a method of least squares. Then, using the approximate straight line, Isat in the case of setting μi to 30 was calculated. Tables 2 and 3 show the slope (unit: A) and the intercept (unit: A) of the approximate straight line and Isat (unit: A) at μi=30.

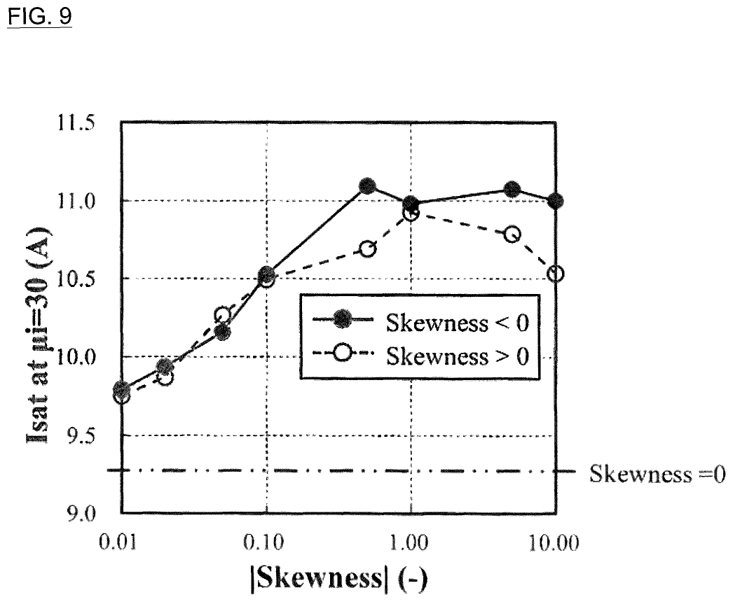

FIG. 9 is a graph of a relationship between the absolute value (|Sₖ|) of skewness and Isat at μi=30. The horizontal axis of FIG. 9 represents the absolute value of the skewness on a logarithmic scale, and the vertical axis of FIG. 9 represents Isat at μi=30. The evaluation results of Examples shown in Table 2 (i.e., Examples satisfying Sₖ≤−0.01) are shown in solid lines with black dots. The evaluation results of Examples shown in Table 3 (i.e., Examples satisfying 0.01≤Sₖ) are shown in dashed lines with white dots. A dashed-and-double-dotted line shown in FIG. 9 is a line indicating Isat in the case of setting μi to 30 at a skewness Sₖ of 0.00 and is unrelated to the horizontal axis of the graph.

On the premise that μi was 30, the increase rate (unit: %) of Isat at each skewness Sₖ was calculated using, as a benchmark, Isat of a Comparative Example having a skewness Sₖ of 0.00. Specifically, the increase rate of Isat at each skewness Sₖ was calculated based on a formula I_{Skew}/I_{STD} (%), where I_{STD} denotes Isat at a skewness Sₖ of 0.00 at μi=30 and I_{Skew} denotes Isat at each skewness Sₖ at μi=30. The increase rate of Isat was defined as good when it was 105% or more or defined as better when it was 110% or more.

TABLE 2

| | | Area ratio | | | | | | | |
|---|---|---|---|---|---|---|---|---|---|
| | | distribution of | | | | Correlation between | | | Isat |
| | Example/ | soft magnetic powder | | Properties | | μi and Isat | | Isat at | increase |
| Sample | Comparative | Average | Skewness | μi | Isat | Slope | Intercept | μi = 30 | rate |
| No. | Example | (%) | (—) | (—) | (A) | (A) | (A) | (A) | (%) |
| A2 | Comparative Example | 75.3 | 0.00 | 22 | 11.0 | −0.23 | 16.22 | 9.3 | 100 |
| A3 | Comparative Example | 80.4 | 0.00 | 27 | 10.1 | | | | |
| A4 | Comparative Example | 85.0 | 0.00 | 30 | 9.4 | | | | |
| A5 | Comparative Example | 89.4 | 0.00 | 34 | 8.2 | | | | |
| B1 | Example | 75.4 | −0.01 | 22 | 11.3 | −0.19 | 15.57 | 9.8 | 106 |
| B2 | Example | 80.2 | −0.01 | 26 | 10.6 | | | | |
| B3 | Example | 85.3 | −0.01 | 29 | 10.0 | | | | |
| B4 | Example | 89.3 | −0.01 | 34 | 9.0 | | | | |
| B5 | Example | 75.2 | −0.02 | 22 | 11.4 | −0.18 | 15.47 | 9.9 | 107 |
| B6 | Example | 80.4 | −0.02 | 26 | 10.7 | | | | |
| B7 | Example | 85.6 | −0.02 | 29 | 10.1 | | | | |
| B8 | Example | 89.2 | −0.02 | 34 | 9.2 | | | | |
| B9 | Example | 75.4 | −0.05 | 20 | 12.0 | −0.19 | 15.79 | 10.2 | 110 |
| B10 | Example | 80.3 | −0.05 | 26 | 11.0 | | | | |
| B11 | Example | 85.4 | −0.05 | 29 | 10.3 | | | | |
| B12 | Example | 89.7 | −0.05 | 34 | 9.4 | | | | |
| B13 | Example | 75.3 | −0.10 | 22 | 12.1 | −0.20 | 16.46 | 10.5 | 114 |
| B14 | Example | 80.1 | −0.10 | 28 | 11.0 | | | | |
| B15 | Example | 85.2 | −0.10 | 32 | 10.0 | | | | |
| B16 | Example | 90.0 | −0.10 | 36 | 9.4 | | | | |
| A7 | Example | 75.0 | −0.50 | 23 | 12.3 | −0.18 | 16.49 | 11.1 | 120 |
| A8 | Example | 80.2 | −0.50 | 29 | 11.4 | | | | |
| A9 | Example | 85.2 | −0.50 | 33 | 10.5 | | | | |
| A10 | Example | 89.6 | −0.50 | 36 | 10.0 | | | | |
| B17 | Example | 75.5 | −1.00 | 23 | 11.8 | −0.13 | 14.80 | 11.0 | 118 |
| B18 | Example | 80.6 | −1.00 | 29 | 11.5 | | | | |
| B19 | Example | 85.6 | −1.00 | 33 | 10.0 | | | | |
| B20 | Example | 89.3 | −1.00 | 36 | 10.5 | | | | |
| B21 | Example | 75.5 | −5.00 | 22 | 12.6 | −0.20 | 17.09 | 11.1 | 119 |
| B22 | Example | 80.6 | −5.00 | 28 | 11.7 | | | | |
| B23 | Example | 84.9 | −5.00 | 33 | 10.2 | | | | |
| B24 | Example | 89.8 | −5.00 | 35 | 10.2 | | | | |
| B25 | Example | 75.2 | −10.00 | 23 | 12.4 | −0.20 | 17.05 | 11.0 | 119 |
| B26 | Example | 80.0 | −10.00 | 28 | 11.6 | | | | |
| B27 | Example | 85.2 | −10.00 | 33 | 10.0 | | | | |
| B28 | Example | 89.3 | −10.00 | 37 | 9.8 | | | | |

TABLE 3

| | | Area ratio distribution | | | | Correlation between | | | Isat |
|---|---|---|---|---|---|---|---|---|---|
| | Example/ | of soft magnetic powder | | Properties | | μi and Isat | | Isat at | increase |
| Sample | Comparative | Average | Skewness | μi | Isat | Slope | Intercept | μi = 30 | rate |
| No. | Example | (%) | (—) | (—) | (A) | (A) | (A) | (A) | (%) |
| A2 | Comparative Example | 75.3 | 0.00 | 22 | 11.0 | −0.23 | 16.22 | 9.3 | 100 |
| A3 | Comparative Example | 80.4 | 0.00 | 27 | 10.1 | | | | |
| A4 | Comparative Example | 85.0 | 0.00 | 30 | 9.4 | | | | |
| A5 | Comparative Example | 89.4 | 0.00 | 34 | 8.2 | | | | |
| C1 | Example | 75.6 | 0.01 | 25 | 11.0 | −0.25 | 17.34 | 9.8 | 105 |
| C2 | Example | 80.6 | 0.01 | 29 | 10.0 | | | | |
| C3 | Example | 84.8 | 0.01 | 32 | 9.3 | | | | |
| C4 | Example | 90.0 | 0.01 | 36 | 8.2 | | | | |
| C5 | Example | 75.1 | 0.02 | 25 | 11.0 | −0.24 | 17.19 | 9.9 | 106 |
| C6 | Example | 80.0 | 0.02 | 30 | 9.9 | | | | |
| C7 | Example | 85.0 | 0.02 | 33 | 9.4 | | | | |
| C8 | Example | 89.3 | 0.02 | 36 | 8.2 | | | | |
| C9 | Example | 75.3 | 0.05 | 27 | 11.0 | −0.22 | 17.01 | 10.3 | 111 |
| C10 | Example | 80.0 | 0.05 | 32 | 9.8 | | | | |
| C11 | Example | 85.0 | 0.05 | 33 | 9.5 | | | | |
| C12 | Example | 89.8 | 0.05 | 39 | 8.3 | | | | |
| C13 | Example | 75.7 | 0.10 | 27 | 11.0 | −0.20 | 16.46 | 10.5 | 113 |
| C14 | Example | 80.2 | 0.10 | 34 | 9.8 | | | | |
| C15 | Example | 84.7 | 0.10 | 36 | 9.5 | | | | |
| C16 | Example | 89.6 | 0.10 | 39 | 8.5 | | | | |
| A12 | Example | 75.0 | 0.50 | 29 | 10.9 | −0.16 | 15.53 | 10.7 | 115 |
| A13 | Example | 80.2 | 0.50 | 35 | 9.8 | | | | |
| A14 | Example | 85.2 | 0.50 | 38 | 9.4 | | | | |
| A15 | Example | 89.6 | 0.50 | 42 | 8.8 | | | | |
| C17 | Example | 75.2 | 1.00 | 29 | 11.1 | −0.18 | 16.29 | 10.9 | 118 |
| C18 | Example | 80.4 | 1.00 | 35 | 10.2 | | | | |
| C19 | Example | 85.2 | 1.00 | 38 | 9.2 | | | | |
| C20 | Example | 89.5 | 1.00 | 42 | 8.9 | | | | |
| C21 | Example | 75.0 | 5.00 | 29 | 11.2 | −0.21 | 17.16 | 10.8 | 116 |
| C22 | Example | 79.9 | 5.00 | 33 | 9.8 | | | | |
| C23 | Example | 84.8 | 5.00 | 37 | 9.4 | | | | |
| C24 | Example | 89.7 | 5.00 | 41 | 8.5 | | | | |
| C25 | Example | 75.3 | 10.00 | 29 | 10.6 | −0.14 | 14.81 | 10.5 | 114 |
| C26 | Example | 80.2 | 10.00 | 35 | 10.0 | | | | |
| C27 | Example | 84.7 | 10.00 | 37 | 9.5 | | | | |
| C28 | Example | 89.6 | 10.00 | 41 | 8.9 | | | | |

From the evaluation results shown in Table 2, it was found that setting the skewness Sₖ of the area ratio distribution of the soft magnetic powder of the magnetic cores to −0.01 or less improved DC superimposition characteristics. More specifically, it was confirmed that, by setting the skewness Sₖ to −0.01 or less, the plotted relationship between μi and Isat in FIG. 7 tended to move closer to the upper right of the graph than the plotted relationship of Comparative Examples. From these results, it was found that setting the skewness Sₖ to −0.01 or less improved DC superimposition characteristics while high permeability was ensured.

According to the solid lines and black dots of FIG. 9, it was confirmed that Isat tended to be improved more along with reduction of the skewness Sₖ in the range of −0.50≤Sₖ≤−0.01 and that Isat tended to remain high in the range of −10.00≤Sₖ≤−0.50. From the results shown in Table 2, FIG. 7, and FIG. 9, it was found that, when Sₖ≤−0.01 was satisfied, the skewness Sₖ was preferably −0.05 or less, more preferably −0.10 or less, or still more preferably −0.50 or less. It was also found that, when Sₖ≤−0.01 was satisfied, the lower limit of the skewness Sₖ was not limited and may have been, for example, −10.00.

From the evaluation results shown in Table 3, it was found that setting the skewness Sₖ of the area ratio distribution of the soft magnetic powder of the magnetic cores to 0.01 or more improved permeability. It was confirmed that, by setting the skewness Sₖ to 0.01 or more, the plotted relationship between μi and Isat in FIG. 8 tended to move closer to the upper right of the graph than the plotted relationship of Comparative Examples. From these results, it was found that setting the skewness Sₖ to 0.01 or more improved DC superimposition characteristics while high permeability was ensured.

According to the dashed lines and white dots of FIG. 9, it was confirmed that Isat tended to be improved more along with increase of the skewness Sₖ in the range of 0.01≤Sₖ≤1.00 and that Isat remained high as well in the range of 1.00≤Sₖ≤10.00. From the results shown in Table 3, FIG. 8, and FIG. 9, it was found that, when 0.01≤Sₖ was satisfied, the skewness Sₖ was preferably 0.05 or more, more preferably 0.10 or more, or still more preferably 0.50 or more. It was also found that, when 0.01≤Sₖ was satisfied, the upper limit of the skewness Sₖ was not limited and may have been, for example, 10.00.

As described above, the evaluation results of Experiment 2 proved that, by controlling the absolute value of the skewness Sₖ to 0.01 or more for the magnetic cores having an average area ratio of the soft magnetic powder of 75% or more and 90% or less, it was possible to improve DC superimposition characteristics while high permeability was ensured.

### Experiment 3

In Experiment 3, fifteen types of magnetic cores shown in Table 4 were manufactured with varied conditions of the insulation films of the large particles. Specifically, for Sample Nos. D1 to D3, the large particles without insulation films were used. For Sample Nos. D4 to D9, the insulation films of the large particles had varied average thicknesses. For Sample Nos. D10 to D15, the insulation films of the large particles had varied compositions. Other specifications (e.g., the composition of the large particles, the average particle size of the large particles, the specifications of the small particles, and the ratio of the large particles to the small particles) of the soft magnetic powder were the same as in Experiment 1, and the magnetic cores were manufactured under the conditions similar to Experiment 1.

In Experiment 3, for each set of conditions of the insulation films of the large particles, three types of magnetic cores were manufactured, which were a Comparative Example having a skewness Sₖ of 0.00, an Example having a skewness Sₖ of −0.50, and an Example having a skewness Sₖ of 0.50. In each Comparative Example, only the first granules were used to control the skewness Sₖ to 0.00. In each Example, the skewness Sₖ was controlled using the mix ratio of the first granules to the second granules as in Experiment 1. In Experiment 3, the molding pressure of each sample was determined so that the corresponding Comparative Example and Examples had about the same permeability, and the increase rate of Isat of each Example was calculated using Isat of the corresponding Comparative Example as a benchmark.

Table 4 shows the evaluation results of Experiment 3.

TABLE 4

| | | Large particles of | | | | | | | |
|---|---|---|---|---|---|---|---|---|---|
| | | soft magnetic powder | | | Area ratio distribution | | Properties | | |
| | Example/ | | | Film | of soft magnetic powder | | | | Isat |
| Sample | Comparative | | | thickness | Average | Skewness | μi | Isat | increase rate |
| No. | Example | Structure | Film | (nm) | (%) | (—) | (—) | (A) | (%) |
| A4 | Comparative Example | Amorphous | P—Zn—Na—Al—O | 20 | 85.0 | 0.00 | 30 | 9.4 | 100 |
| A8 | Example | | | | 80.2 | −0.50 | 29 | 11.4 | 121 |
| A12 | Example | | | | 75.0 | 0.50 | 29 | 10.9 | 116 |
| D1 | Comparative Example | Amorphous | No film | — | 85.2 | 0.00 | 32 | 8.1 | 100 |
| D2 | Example | | | | 80.7 | −0.50 | 32 | 9.7 | 120 |
| D3 | Example | | | | 75.6 | 0.50 | 32 | 9.5 | 117 |
| D4 | Comparative Example | Amorphous | P—Zn—Na—Al—O | 1 | 85.2 | 0.00 | 32 | 8.2 | 100 |
| D5 | Example | | | | 80.5 | −0.50 | 32 | 9.8 | 120 |
| D6 | Example | | | | 75.4 | 0.50 | 32 | 9.5 | 116 |
| D7 | Comparative Example | Amorphous | P—Zn—Na—Al—O | 100 | 85.2 | 0.00 | 28 | 9.6 | 100 |
| D8 | Example | | | | 79.8 | −0.50 | 28 | 11.2 | 117 |
| D9 | Example | | | | 75.1 | 0.50 | 28 | 11.0 | 115 |
| D10 | Comparative Example | Amorphous | Bi—Zn—B—Si—O | 20 | 85.1 | 0.00 | 30 | 9.3 | 100 |
| D11 | Example | | | | 80.3 | −0.50 | 30 | 11.2 | 120 |
| D12 | Example | | | | 75.2 | 0.50 | 30 | 10.8 | 116 |
| D13 | Comparative Example | Amorphous | Ba—Zn—B—Si—Al—O | 20 | 85.3 | 0.00 | 30 | 9.5 | 100 |
| D14 | Example | | | | 80.1 | −0.50 | 30 | 11.3 | 119 |
| D15 | Example | | | | 75.1 | 0.50 | 30 | 11.0 | 116 |

From the evaluation results of Sample Nos. D1 to D3, it was found that, regardless of whether the insulation films were included or not, DC superimposition characteristics were improved based on the skewness Sₖ. From the evaluation results of Sample Nos. D4 to D15, it was found that, even with varied compositions or thicknesses of the insulation films, DC superimposition characteristics were improved based on the skewness Sₖ.

### Experiment 4

### Sample Nos. E1 to E15

For Sample Nos. E1 to E15, the large particles and the small particles were mixed at a ratio shown in Table 5 to manufacture magnetic cores. The specifications (particle composition, average particle size, film composition, and average film thickness) of the large particles and the small particles used for Sample Nos. E1 to E15 were the same as in Experiment 1. Manufacturing conditions of the large particles and the small particles were the similar to Experiment 1 except for their ratio.

### Sample Nos. F1 to F12

For Sample Nos. F1 to F12, the composition of small particles was changed to a composition shown in Table 6 to manufacture magnetic cores. In Sample Nos. F1 to F12, the small particles had an average particle size of 1 μm. In Sample Nos. F1 to F12, the large particles accounted for 80 wt %, and the small particles accounted for 20 wt %. Experiment conditions other than the above were similar to Experiment 1.

In Experiment 4, for each set of varied manufacturing conditions (the ratio of the large particles to the small particles (Table 5) and the composition of the small particles (Table 6)), three types of magnetic cores were manufactured, which were a Comparative Example having a skewness Sₖ of 0.00, an Example having a skewness Sₖ of −0.50, and an Example having a skewness Sₖ of 0.50. In Experiment 4, the molding pressure of each sample was determined so that the corresponding Comparative Example and Examples had about the same permeability, and the increase rate of Isat of each Example was calculated using Isat of the corresponding Comparative Example as a benchmark.

TABLE 5

| | | Soft magnetic powder | | | | Magnetic | Properties | | |
|---|---|---|---|---|---|---|---|---|---|
| | Example/ | | Small | Ratio (wt %) | | core | | | Isat |
| Sample | Comparative | Large particle | particle | Large | Small | Skewness | μi | Isat | increase rate |
| No. | Example | composition | composition | particles | particles | (—) | (—) | (A) | (%) |
| E1 | Comparative Example | Fe—Co—B—P—Si—Cr | — | 100 | — | 0.00 | 28 | 10.1 | 100 |
| E2 | Example | | | | | −0.50 | 29 | 11.9 | 118 |
| E3 | Example | | | | | 0.50 | 28 | 11.5 | 114 |
| A4 | Comparative Example | Fe—Co—B—P—Si—Cr | Fe | 80 | 20 | 0.00 | 30 | 9.4 | 100 |
| A8 | Example | | | | | −0.50 | 29 | 11.4 | 121 |
| A12 | Example | | | | | 0.50 | 29 | 10.9 | 116 |
| E4 | Comparative Example | Fe—Co—B—P—Si—Cr | Fe | 60 | 40 | 0.00 | 28 | 10.3 | 100 |
| E5 | Example | | | | | −0.50 | 28 | 12.4 | 120 |
| E6 | Example | | | | | 0.50 | 27 | 11.6 | 113 |
| E7 | Comparative Example | Fe—Co—B—P—Si—Cr | Fe | 40 | 60 | 0.00 | 26 | 10.9 | 100 |
| E8 | Example | | | | | −0.50 | 27 | 12.9 | 118 |
| E9 | Example | | | | | 0.50 | 26 | 12.4 | 114 |
| E10 | Comparative Example | Fe—Co—B—P—Si—Cr | Fe | 20 | 80 | 0.00 | 24 | 11.7 | 100 |
| E11 | Example | | | | | −0.50 | 25 | 13.8 | 118 |
| E12 | Example | | | | | 0.50 | 25 | 13.4 | 115 |
| E13 | Comparative Example | — | Fe | — | 100 | 0.00 | 22 | 12.3 | 100 |
| E14 | Example | | | | | −0.50 | 22 | 14.6 | 119 |
| E15 | Example | | | | | 0.50 | 21 | 14.3 | 116 |

TABLE 6

| | | Soft magnetic powder | | | | Magnetic core | | | |
|---|---|---|---|---|---|---|---|---|---|
| | Example/ | | Small | Ratio (wt %) | | | | | Isat |
| Sample | Comparative | Large particle | particle | Large | Small | Skewness | μi | Isat | increase rate |
| No. | Example | composition | composition | particles | particles | (—) | (—) | (A) | (%) |
| A4 | Comparative Example | Fe—Co—B—P—Si—Cr | Fe | 80 | 20 | 0.00 | 30 | 9.4 | 100 |
| A8 | Example | | | | | −0.50 | 29 | 11.4 | 121 |
| A12 | Example | | | | | 0.50 | 29 | 10.9 | 116 |
| F1 | Comparative Example | Fe—Co—B—P—Si—Cr | Fe—Ni | 80 | 20 | 0.00 | 32 | 7.6 | 100 |
| F2 | Example | | | | | −0.50 | 32 | 9.2 | 121 |
| F3 | Example | | | | | 0.50 | 31 | 8.9 | 117 |
| F4 | Comparative Example | Fe—Co—B—P—Si—Cr | Fe—Si | 80 | 20 | 0.00 | 31 | 10.2 | 100 |
| F5 | Example | | | | | −0.50 | 32 | 12.3 | 121 |
| F6 | Example | | | | | 0.50 | 31 | 11.9 | 117 |
| F7 | Comparative Example | Fe—Co—B—P—Si—Cr | Fe—Co | 80 | 20 | 0.00 | 29 | 10.7 | 100 |
| F8 | Example | | | | | −0.50 | 30 | 12.8 | 120 |
| F9 | Example | | | | | 0.50 | 30 | 12.4 | 116 |
| F10 | Comparative Example | Fe—Co—B—P—Si—Cr | Co | 80 | 20 | 0.00 | 28 | 10.4 | 100 |
| F11 | Example | | | | | −0.50 | 27 | 12.5 | 120 |
| F12 | Example | | | | | 0.50 | 28 | 12.2 | 117 |

From the evaluation results shown in Table 5, it was found that, even with varied ratios of the large particles to the small particles, DC superimposition characteristics were improved based on the skewness St. It was also found that, in terms of increasing permeability, the large particles accounted for preferably 60 wt % or more.

From the evaluation results shown in Table 6, it was found that, even with varied compositions of the small particles, DC superimposition characteristics were improved based on the skewness Sₖ.

### Experiment 5

In Experiment 5, fifteen types of magnetic cores were manufactured using a soft magnetic powder including large particles, medium particles, and small particles. The specifications (particle composition, average particle size, film composition, and average film thickness) of the large particles and the small particles used for each sample of Experiment 5 were similar to those of Experiment 1. Together with the large particles and the small particles, the medium particles having a composition shown in Table 7 were added at the time of manufacture of the first granules. The medium particles used for Sample Nos. G1 to G15 had an average particle size of 5 μm. In Sample Nos. G1 to G15, the large particles accounted for 80 wt %, the medium particles accounted for 10 wt %, and the small particles accounted for 10 wt %. Experiment conditions other than the above were similar to Experiment 1.

In Experiment 5, for each soft magnetic powder configuration, three types of magnetic cores were manufactured, which were a Comparative Example having a skewness Sₖ of 0.00, an Example having a skewness Sₖ of −0.50, and an Example having a skewness Sₖ of 0.50. In Experiment 5, the molding pressure of each sample was determined so that the corresponding Comparative Example and Examples had about the same permeability, and the increase rate of Isat of each Example was calculated using Isat of the corresponding Comparative Example as a benchmark.

TABLE 7

| | | | | | | | | Magnetic core | | | |
|---|---|---|---|---|---|---|---|---|---|---|---|
| | | Soft magnetic powder | | | | | | | | | Isat |
| | Example/ | Large | Medium | Small | Ratio (wt %) | | | | | | increase |
| Sample | Comparative | particle | particle | particle | Large | Medium | Small | Skewness | μi | Isat | rate |
| No. | Example | composition | composition | composition | particles | particles | particles | (—) | (—) | (A) | (%) |
| A4 | Comparative | Fe—Co—B—P—Si—Cr | — | Fe | 80 | — | 20 | 0.00 | 30 | 9.4 | 100 |
| | Example | | | | | | | | | | |
| A8 | Example | | | | | | | −0.50 | 29 | 11.4 | 121 |
| A12 | Example | | | | | | | 0.50 | 29 | 10.9 | 116 |
| G1 | Comparative | Fe—Co—B—P—Si—Cr | Fe—Ni | Fe | 80 | 10 | 10 | 0.00 | 34 | 7.5 | 100 |
| | Example | | | | | | | | | | |
| G2 | Example | | | | | | | −0.50 | 33 | 9.0 | 120 |
| G3 | Example | | | | | | | 0.50 | 34 | 8.7 | 116 |
| G4 | Comparative | Fe—Co—B—P—Si—Cr | Fe—Si | Fe | 80 | 10 | 10 | 0.00 | 33 | 9.8 | 100 |
| | Example | | | | | | | | | | |
| G5 | Example | | | | | | | −0.50 | 32 | 11.9 | 121 |
| G6 | Example | | | | | | | 0.50 | 32 | 11.5 | 117 |
| G7 | Comparative | Fe—Co—B—P—Si—Cr | Fe—Co | Fe | 80 | 10 | 10 | 0.00 | 31 | 10.6 | 100 |
| | Example | | | | | | | | | | |
| G8 | Example | | | | | | | −0.50 | 30 | 12.5 | 118 |
| G9 | Example | | | | | | | 0.50 | 31 | 12.2 | 115 |
| G10 | Comparative | Fe—Co—B—P—Si—Cr | Co | Fe | 80 | 10 | 10 | 0.00 | 30 | 10.3 | 100 |
| | Example | | | | | | | | | | |
| G11 | Example | | | | | | | −0.50 | 29 | 12.4 | 120 |
| G12 | Example | | | | | | | 0.50 | 29 | 12.1 | 117 |
| G13 | Comparative | Fe—Co—B—P—Si—Cr | Fe—Si—B—C—Cr | Fe | 80 | 10 | 10 | 0.00 | 33 | 9.6 | 100 |
| | Example | | | | | | | | | | |
| G14 | Example | | | | | | | −0.50 | 33 | 11.4 | 119 |
| G15 | Example | | | | | | | 0.50 | 32 | 11.1 | 116 |

From the evaluation results shown in Table 7, it was found that, even when the soft magnetic powder was made up of three types of particles groups, DC superimposition characteristics were improved based on the skewness Sₖ.

### Experiment 6

In Experiment 6, magnetic cores shown in Tables 8 to 10 were manufactured with varied compositions of large particles. For Sample Nos. H1 to H9 of Table 8, large particles having an amorphous structure were used. For Sample Nos. I1 to I9 of Table 9, large particles having a nanocrystalline structure were used. For Sample Nos. J1 to J12 of Table 10, large particles having a crystalline structure were used. The large particles used for each Example of Experiment 6 had an average particle size of 25 μm. The large particles used for each sample included insulation films having an average thickness of 20 nm and the same composition as in Experiment 1.

In Experiment 6, for each composition of the large particles, three types of magnetic cores were manufactured, which were a Comparative Example having a skewness Sₖ of 0.00, an Example having a skewness Sₖ of −0.50, and an Example having a skewness Sₖ of 0.50. In Experiment 6, the molding pressure of each sample was determined so that the corresponding Comparative Example and Examples had about the same permeability, and the increase rate of Isat of each Example was calculated using Isat of the corresponding Comparative Example as a benchmark.

TABLE 8

| | | Soft magnetic powder | | | | | | | Properties | | |
|---|---|---|---|---|---|---|---|---|---|---|---|
| | | | | | | | | | | | Isat |
| | Example/ | | | Small | | | Area ratio distribution | | | | in- |
| | Compar- | | | particle | Ratio (wt %) | | of soft magnetic powder | | | | crease |
| Sample | ative | Large particles | | compo- | Large | Small | Average | Skewness | μi | Isat | rate |
| No. | Example | Composition | Structure | sition | particles | particles | (%) | (—) | (—) | (A) | (%) |
| A4 | Compar- | Fe_{57.4}—Co_{24.6}—B₁₁—P₃—Si₃—Cr₁ | Amor- | Fe | 80 | 20 | 85.0 | 0.00 | 30 | 9.4 | 100 |
| | ative | | phous | | | | | | | | |
| | Example | | | | | | | | | | |
| A8 | Example | | | | | | 80.2 | −0.50 | 29 | 11.4 | 121 |
| A12 | Example | | | | | | 75.0 | 0.50 | 29 | 10.9 | 116 |
| H1 | Compar- | Fe₇₃—B₁₁—Si₁₁—C₃—Cr₂ | Amor- | Fe | 80 | 20 | 85.1 | 0.00 | 31 | 8.7 | 100 |
| | ative | | phous | | | | | | | | |
| | Example | | | | | | | | | | |
| H2 | Example | | | | | | 80.4 | −0.50 | 31 | 10.3 | 118 |
| H3 | Example | | | | | | 75.2 | 0.50 | 30 | 10.1 | 116 |
| H4 | Compar- | Fe₇₉—B_{13.5}—Si_{5.5}—C₂ | Amor- | Fe | 80 | 20 | 85.2 | 0.00 | 30 | 9.1 | 100 |
| | ative | | phous | | | | | | | | |
| | Example | | | | | | | | | | |
| H5 | Example | | | | | | 80.3 | −0.50 | 30 | 10.7 | 118 |
| H6 | Example | | | | | | 75.1 | 0.50 | 31 | 10.6 | 116 |
| H7 | Compar- | Fe₇₅—B₁₅—Si₁₀ | Amor- | Fe | 80 | 20 | 85.3 | 0.00 | 29 | 8.6 | 100 |
| | ative | | phous | | | | | | | | |
| | Example | | | | | | | | | | |
| H8 | Example | | | | | | 80.4 | −0.50 | 30 | 10.2 | 119 |
| H9 | Example | | | | | | 75.1 | 0.50 | 30 | 10.1 | 117 |

TABLE 9

| | | Soft magnetic powder | | | | | | | Properties | | |
|---|---|---|---|---|---|---|---|---|---|---|---|
| | | | | | | | | | | | Isat |
| | Example/ | | | Small | Ratio (wt %) | | Area ratio distribution | | | | in- |
| | Compar- | | | particle | Large | Small | of soft magnetic powder | | | | crease |
| Sample | ative | Large particles | | compo- | parti- | parti- | Average | Skewness | μi | Isat | rate |
| No. | Example | Composition | Structure | sition | cles | cles | (%) | (—) | (—) | (A) | (%) |
| 11 | Compar- | Fe_{73.5}—Nb₃—B₉—Si_{13.5}—Cu | Nano- | Fe | 80 | 20 | 85.2 | 0.00 | 32 | 8.5 | 100 |
| | ative | | crystalline | | | | | | | | |
| | Example | | | | | | | | | | |
| 12 | Example | | | | | | 80.5 | −0.50 | 33 | 10.1 | 119 |
| 13 | Example | | | | | | 75.3 | 0.50 | 32 | 9.9 | 116 |
| 14 | Compar- | Fe_{83.3}—Si₂—B₉—P₅—Cu_{0.7} | Nano- | Fe | 80 | 20 | 85.2 | 0.00 | 33 | 8.7 | 100 |
| | ative | | crystalline | | | | | | | | |
| | Example | | | | | | | | | | |
| 15 | Example | | | | | | 80.4 | −0.50 | 32 | 10.5 | 121 |
| 16 | Example | | | | | | 75.1 | 0.50 | 32 | 10.3 | 118 |
| 17 | Compar- | Fe_{78.6}—Nb₇—B₉—P₃—Si₂—Cr_{0.3}S_{0.1} | Nano- | Fe | 80 | 20 | 85.3 | 0.00 | 31 | 9.3 | 100 |
| | ative | | crystalline | | | | | | | | |
| | Example | | | | | | | | | | |
| 18 | Example | | | | | | 80.3 | −0.50 | 32 | 11.1 | 119 |
| 19 | Example | | | | | | 75.2 | 0.50 | 32 | 10.7 | 115 |

TABLE 10

| | | Soft magnetic powder | | | | | Area ratio distribution | | Properties | | |
|---|---|---|---|---|---|---|---|---|---|---|---|
| | Example/ | | | Small | Ratio (wt %) | | of soft magnetic powder | | | | Isat |
| Sample | Comparative | Large particles | | particle | Large | Small | Average | Skewness | μi | Isat | increase rate |
| No. | Example | Composition | Structure | composition | particles | particles | (%) | (—) | (—) | (A) | (%) |
| J1 | Comparative | Fe_{89.4}—Si_{8.6}—Cr₂ | Crystalline | Fe | 80 | 20 | 85.2 | 0.00 | 30 | 9.6 | 100 |
| | Example | | | | | | | | | | |
| J2 | Example | | | | | | 80.3 | −0.50 | 29 | 11.4 | 119 |
| J3 | Example | | | | | | 75.1 | 0.50 | 29 | 10.9 | 114 |
| J4 | Comparative | Fe_{91.4}—Si_{8.6} | Crystalline | Fe | 80 | 20 | 85.3 | 0.00 | 30 | 9.7 | 100 |
| | Example | | | | | | | | | | |
| J5 | Example | | | | | | 80.6 | −0.50 | 29 | 11.4 | 118 |
| J6 | Example | | | | | | 75.3 | 0.50 | 30 | 11.2 | 115 |
| J7 | Comparative | Fe₈₈—Si₁₂ | Crystalline | Fe | 80 | 20 | 85.2 | 0.00 | 31 | 9.5 | 100 |
| | Example | | | | | | | | | | |
| J8 | Example | | | | | | 80.5 | −0.50 | 31 | 11.3 | 119 |
| J9 | Example | | | | | | 75.2 | 0.50 | 30 | 10.9 | 115 |
| J10 | Comparative | Fe_{73.7}—Si_{15.5}—Al_{10.8} | Crystalline | Fe | 80 | 20 | 85.2 | 0.00 | 34 | 7.1 | 100 |
| | Example | | | | | | | | | | |
| J11 | Example | | | | | | 80.2 | −0.50 | 34 | 8.5 | 120 |
| J12 | Example | | | | | | 75.1 | 0.50 | 33 | 8.2 | 115 |

From the evaluation results shown in Tables 8 to 10 of Experiment 6, it was found that, regardless of the composition of the large particles, DC superimposition characteristics were improved based on the skewness Sₖ.

### REFERENCE NUMERALS

2 . . . magnetic core
1 . . . soft magnetic powder
10 . . . metal particle
10a . . . large particle
10b . . . small particle
10c . . . medium particle
3 . . . resin
20 . . . square region
100 . . . magnetic component
5 . . . coil
5a, 5b . . . end portion
6, 8 . . . external electrode

What is claimed is:

1. A magnetic core comprising a soft magnetic powder, wherein
the soft magnetic powder accounts for an area ratio of 75% or more and 90% or less of a section of the magnetic core on average; and
the area ratio has a distribution with a skewness of 0.01 or more in absolute value,
the skewness being identified by calculating area ratios of the soft magnetic powder in respective square regions, the square regions being defined by dividing the section using a regular-interval grid and having an area of (2D_{MAX})² each, where D_{MAX} denotes a maximum particle size of the soft magnetic powder in the section.

2. The magnetic core according to claim 1, wherein the skewness of the distribution of the area ratio is 0.05 or more in absolute value.

3. A magnetic component comprising the magnetic core according to claim 1 and a coil.

4. A magnetic component comprising the magnetic core according to claim 2 and a coil.
